(19) United States
(12) Patent Application Publication
(10) Pub. No.: US 2022/0383272 A1
(43) Pub. Date: Dec. 1, 2022

(54) MATERIAL TREATMENT MANAGEMENT, TRACKING AND/OR REGULATION COMPLIANCE PLATFORM, SYSTEM AND METHOD

(71) Applicant: Diversys Software Inc., Toronto (CA)

(72) Inventor: Zachary Wayne Dryman, Toronto (CA)

(21) Appl. No.: 17/770,769

(22) PCT Filed: Oct. 28, 2020
(86) PCT No.: PCT/CA2020/051441

§ 371 Date: Apr. 21, 2022

Related U.S. Application Data
(60) Provisional application No. 62/926,945, filed on Oct. 28, 2019.

(51) Int. Cl. G06Q 10/00; G06Q 10/08; G06Q 30/00

(52) U.S. Cl. CPC G06Q 10/30; G06Q 10/0832; G06Q 30/018

(57) ABSTRACT

Described are various embodiments of a material treatment management, tracking and/or regulation compliance platform, system and method. In one embodiment, a digital material treatment management system comprises a digitally executed material treatment management instance configuration interface, a digitally executed material treatment management instance participant interface; and a network-accessible digital processing environment storing network-executable instructions to concurrently execute respectively configured material treatment management instances and compile, for each one thereof, digital data representative of each of plural predefined material treatment transactions associated therewith for compliance with its predefined material treatment stream.

### FIELD OF THE DISCLOSURE

The present disclosure relates to material management and, in particular, to a derived material treatment management, tracking, and/or regulation compliance platform, system and method.

### BACKGROUND

In recent decades, increasing interest in the green movement, sustainability, and the potential economic benefits of reusing materials has given rise to a worldwide increase in legislation regarding the proper documentation, tracking and reporting of waste management and product recycling. However, such operations are traditionally performed by individual parties with conventional pen-and-paper methods, which in addition to reducing productivity due the needs of sorting and managing paper-based inputs, can be prone to error and fraud. Particularly challenging is the fact that products often contain several constituent materials, some of which may change hands several times over their lifetime.

In very select cases, digital applications have been developed in an effort to streamline recycling documentation processes. For instance, Green Halo Systems provides a website for reporting and tracking the diversion of debris from construction sites to minimise the contribution of such waste to landfills (RODATOS, C. D., “Waste Management and Recycling Tracking System.” WO2012019202A3). Similarly, eTracks Tire Management Systems provides an application for coordinating the recycling of used tires. This system was hard-coded as a singular instance to perform recycling reporting and management tasks to accommodate the specific needs of a single entity, Ontario Tire Stewardship. A singular instance, residing on a dedicated server (herein referred to as a single-tenant system), is typically not amenable to customization and thus, provides limited prospects for the implementation of multiple instances, particularly in that distinct instances must typically reside on distinctly operated servers and thus require independent management and maintenance.

Existing platforms are thus highly specialised, comprising inflexible software, and generally constrained to accommodate local (e.g. provincial) regulations.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for a material treatment management, tracking, and/or regulation compliance platform, system and method that overcome some of the drawbacks of known techniques, or at least, provides a useful alternative thereto. Some aspects of this disclosure provide examples of such processes and systems.

In accordance with one aspect, there is provided a digital material treatment management system comprising: a digitally executed material treatment management instance configuration interface digitally accessible to respective instance management authorities via corresponding digital communication network connections and comprising digitally executable instructions to digitally define, for respectively configurable material treatment management instances and based on respective digital inputs from said respective instance management authorities, respective prescribed material treatment process streams each respectively comprising multiple predefined material treatment transactions; a digitally executed material treatment management instance participant interface digitally accessible to respective instance participant authorities via corresponding digital communication network connections and comprising digitally executable instructions to acquire, for each of said respective material treatment management instances and in respect of each of said respective instance participant authorities, digital data representative of respective material treatment transactions in compliance with said respectively predefined material treatment streams; and a network-accessible digital processing environment storing network-executable instructions to concurrently execute said respectively configured material treatment management instances and compile, for each one thereof, said digital data representative of each of said predefined material treatment transactions associated therewith for compliance with its predefined material treatment stream.

In accordance with one embodiment, at least some of said respective prescribed material treatment process streams are defined in accordance with respective material treatment regulations, and wherein said network-accessible digital processing environment actively compiles said digital data for compliance with said respective material treatment regulations.

In accordance with one embodiment, the respective material treatment regulations comprise respective jurisdictional or material-specific treatment regulations.

In accordance with one embodiment, at least some of said respective prescribed material treatment process streams have defined in association therewith respective material treatment performance metrics, and wherein said network-accessible digital processing environment actively compiles said digital data against said respective material treatment performance metrics.

In accordance with one embodiment, the material treatment performance metrics comprise at least one material recovery, reuse or recycling metric.

In accordance with one embodiment, a given instance is related to a given material recovery process for a prescribed product type, and wherein said digital data associated with a given transaction comprises a constituent product material identifier and value representative of a constituent product material and constituent material quantity treated in said given transaction.

In accordance with one embodiment, the prescribed product type has multiple constituent materials associated therewith as predefined via said configuration interface, and wherein said constituent product material identifier is selectable from multiple such identifiers via said participant interface.

In accordance with one embodiment, a given respectively predefined material treatment stream comprises multiple constituent material recovery streams respectively associated with said multiple constituent materials such that each of said multiple constituent material recovery streams are monitored via said network-accessible digital processing environment for compliance by said management authority or a third-party oversight authority designated thereby or associated therewith.

In accordance with one embodiment, at least some of said constituent material recovery streams comprise distinct designated material treatment transaction types.

In accordance with one embodiment, the participant authorities comprise at least one of a material producer, collector, hauler, post-consumption processor, sorter, manufacturer, consumer, recycler, or safe disposal manager.

In accordance with one embodiment, the instance management authorities comprise at least one of a Producer Responsibility Organisation (PRO), stewardship, oversight compliance officer, or third-party auditor.

In accordance with another aspect, there is provided a computer-implemented process executable to implement a digital material treatment management process by: digitally interfacing with a material treatment management instance configuration interface digitally accessible to respective instance management authorities via corresponding digital communication network connections and comprising digitally executable instructions to digitally define, for respectively configurable material treatment management instances and based on respective digital inputs from said respective instance management authorities, respective prescribed material treatment process streams each respectively comprising multiple predefined material treatment transactions; digitally interfacing with a material treatment management instance participant interface digitally accessible to respective instance participant authorities via corresponding digital communication network connections and comprising digitally executable instructions to acquire, for each of said respective material treatment management instances and in respect of each of said respective instance participant authorities, digital data representative of respective material treatment transactions in compliance with said respectively predefined material treatment streams; concurrently executing said respectively configured material treatment management instances and compiling, for each one thereof, said digital data representative of each of said predefined material treatment transactions associated therewith for compliance with its predefined material treatment stream.

In one embodiment, at least some of said respective prescribed material treatment process streams are defined in accordance with respective material treatment regulations, and wherein said compiling comprises actively compiling said digital data for compliance with said respective material treatment regulations.

In one embodiment, the respective material treatment regulations comprise respective jurisdictional or material-specific treatment regulations.

In one embodiment, at least some of said respective prescribed material treatment process streams have defined in association therewith respective material treatment performance metrics, and wherein said compiling comprises actively compiling said digital data against said respective material treatment performance metrics.

In one embodiment, the material treatment performance metrics comprise at least one material recovery, reuse or recycling metric.

In one embodiment, a given instance is related to a given material recovery process for a prescribed product type, and wherein said digital data associated with a given transaction comprises a constituent product material identifier and value representative of a constituent product material and constituent material quantity treated in said given transaction.

In one embodiment, the prescribed product type has multiple constituent materials associated therewith as predefined via said configuration interface, and wherein said constituent product material identifier is selectable from multiple such identifiers via said participant interface.

In one embodiment, a given respectively predefined material treatment stream comprises multiple constituent material recovery streams respectively associated with said multiple constituent materials such that each of said multiple constituent material recovery streams are monitored for compliance by said management authority or a third-party oversight authority designated thereby or associated therewith.

In one embodiment, at least some of said constituent material recovery streams comprise distinct designated material treatment transaction types.

In one embodiment, the participant authorities comprise at least one of a material producer, collector, hauler, post-consumption processor, sorter, manufacturer, consumer, recycler, or safe disposal manager.

In one embodiment, said instance management authorities comprise at least one of a Producer Responsibility Organisation (PRO), stewardship, oversight compliance officer, or third-party auditor.

In accordance with another aspect, there is provided a computer-readable medium comprising digitally executable instructions stored thereon for execution by a digital processor to implement a digital material treatment management process as defined above.

In accordance with another aspect, there is provided a digital material treatment management system comprising: a network-accessible digital processing environment storing network-executable instructions to: remotely interface with a digitally executed material treatment stream management configuration interface digitally accessible to respective stream management authorities via corresponding digital communication network connections and comprising digitally executable instructions to digitally define, based on respective digital inputs from said respective stream management authorities, respective prescribed material treatment process streams each respectively comprising multiple predefined material treatment transactions; remotely interface with a digitally executed material treatment stream participant interface digitally accessible to respective participant authorities via corresponding digital communication network connections and comprising digitally executable instructions to acquire, for each of said respective material treatment streams and in respect of each of said respective participant authorities, digital data representative of respective material treatment transactions in compliance with said respectively predefined material treatment streams; and concurrently administer said respectively configured material treatment streams and compile, for each one thereof, said digital data representative of each of said predefined material treatment transactions associated therewith for compliance with its predefined material treatment stream.

In one embodiment, the system further comprises said digitally executed material treatment stream management configuration interface.

In one embodiment, the system further comprises said digitally executed material treatment stream participant interface.

In one embodiment, at least some of said respective prescribed material treatment process streams are defined in accordance with respective material treatment regulations, and wherein said network-accessible digital processing environment actively compiles said digital data for compliance with said respective material treatment regulations.

In one embodiment, the respective material treatment regulations comprise respective jurisdictional or material-specific treatment regulations.

In one embodiment, at least some of said respective prescribed material treatment process streams have defined in association therewith respective material treatment performance metrics, and wherein said network-accessible digital processing environment actively compiles said digital data against said respective material treatment performance metrics.

In one embodiment, the material treatment performance metrics comprise at least one material recovery, reuse or recycling metric.

In one embodiment, a given instance is related to a given material recovery process for a prescribed product type, and wherein said digital data associated with a given transaction comprises a constituent product material identifier and value representative of a constituent product material and constituent material quantity treated in said given transaction.

In one embodiment, the prescribed product type has multiple constituent materials associated therewith as predefined via said configuration interface, and wherein said constituent product material identifier is selectable from multiple such identifiers via said participant interface.

In one embodiment, a given respectively predefined material treatment stream comprises multiple constituent material recovery streams respectively associated with said multiple constituent materials such that each of said multiple constituent material recovery streams are monitored via said network-accessible digital processing environment for compliance by said management authority or a third-party oversight authority designated thereby or associated therewith.

In one embodiment, at least some of said constituent material recovery streams comprise distinct designated material treatment transaction types.

In one embodiment, the participant authorities comprise at least one of a material producer, collector, hauler, post-consumption processor, sorter, manufacturer, consumer, recycler, or safe disposal manager.

In one embodiment, the management authorities comprise at least one of a Producer Responsibility Organisation (PRO), stewardship, oversight compliance officer, or third-party auditor.

Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIGS. 1a and 1b are schematic diagrams of various interactions of relevant parties within a digital material treatment management platform, in accordance with various embodiments;

FIGS. 2a and 2b are schematic diagrams of workflows of an instance of a material treatment management system, in accordance with at least one embodiment;

FIG. 3 is an illustrative screenshot of a graphical user access interface for a material treatment management system, in accordance with at least one embodiment;

FIGS. 4a to 18 are illustrative screenshots of a graphical user interface operable to configure an instance of a material treatment management system, in accordance with at least one embodiment;

FIGS. 19 to 21j are illustrative screenshots of a graphical user interface operable to record, view and track material treatment transactions against a designated instance of a material treatment management system, in accordance with at least one embodiment;

FIG. 22 is a schematic diagram of a material management stream enrollment and approval process, in accordance with one embodiment;

FIG. 23 is a schematic diagram of a material treatment transaction management process, in accordance with one embodiment; and

FIGS. 24a to 24c are illustrative screenshots of a graphical user interface operable to allow a user to login to and synchronize with a material management system, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (e.g., XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this invention belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “material treatment” will be used herein to include, in a non-limiting fashion, terms such as “recycling”, “repurposing”, “waste management” and/or the like, which may be herein used interchangeably to represent the treatment of any materials, products, and/or goods, or constituent materials, products and/or goods (also herein referred to simply as “materials”), for which there exists a motivation to treat responsibly. Treatment may include, but is not limited to, any one or more of management, recording, tracking, recycling, repurposing, transformation, reusing, responsibly disposing of, reporting on, and/or the like, of a material. While there is no restriction on the scope of materials that may be treated, examples may include, but are not limited to, metals, synthetic materials, construction material, electronics, minerals, precious metals, heavy metals, chemicals, manufacture or processing waste, radioactive substances, batteries, fuels, paints, tires, etc. Motivation for responsible handling, treatment and/or reporting may be intrinsic, due to policy, regulation, ordinance, law, or the like, which may vary by region and/or jurisdiction (e.g. municipality, county, state, province, country, etc.) or again be enacted, imposed, proposed or encouraged by distinct material treatment best practices bodies or organizations. Such treatment may also apply to any one or more stages within the lifetime of a material, including, but not limited to, production, collection, hauling, processing, sorting, manufacturing, consumption, repurposing, reusing and/or recycling of a material, as well as any transaction that occurs by which a material is exchanged or the party in possession of a material changes.

For simplicity, the following will interchangeably refer to the treatment of materials as a whole (e.g. goods, products, devices or the like as a whole), or constituent materials thereof (e.g. constituent materials, components, parts, elements or the like thereof), with the understanding that different treatment protocols may be applied or layered in parallel and/or serially depending on the nature, manufacture, composition, assembly, construction, or fashion of such materials, or constituent materials thereof, and available or preferred deconstruction, disassembly, recycling, repurposing, transformation or like processing therefor. Notably, different material treatment processing options may be applied or considered depending on the nature of the material, and the industry and/or jurisdiction within which it is, was or is to be employed or redirected.

As noted above, a digital platform for waste management can be hard-coded to perform recycling reporting and management tasks for a specific application, in a specific jurisdiction. For instance, a platform for the tracking of tire rubber was purpose-built to accommodate the specific needs of a single entity, such as the Ontario Tire Stewardship. Such a singular instance, residing on a dedicated server is herein referred to as a single-tenant system. Such single-tenant systems are typically not amenable to customization and thus, provide limited prospects for the implementation of multiple instances, particularly in that distinct instances must typically reside on distinctly operated servers and thus require independent management and maintenance.

The systems and methods described herein provide, in accordance with different embodiments, various examples in which materials subject to responsible treatment protocols, such as for recycling, repurposing, waste management or the like, can be monitored, managed, overseen and reported on within a single robust web- or cloud-based platform by many or all relevant parties throughout the lifetime of said materials. Accordingly, while conventional single-tenant systems may provide limited to no flexibility with respect to the management of more than one material, various embodiments herein disclosed relate to a common digital platform for the management of multiple material and/or material waste streams, which may in turn comprise multiple instances of waste management. Each waste stream and/or instance thereof may be configurable, in accordance with various embodiments, within the common platform to provide customised instances (or material treatment streams) in which various parties may participate, either jointly, or within the virtual confines of their own branded, segregated and/or jurisdictionally sanctioned environments, to name a few examples. With respect to the description of various examples provided herein, such relevant parties may include, but are not limited to, any user or client involved in the production, collection, hauling, sorting, processing or manufacturing or consumption of goods, products, or materials. Additional relevant parties may also include an oversight committee, such as a government authority, or producer responsible organisation (PRO), stewardship, or other such party responsible for reporting and managing obligations regarding the treatment of such goods, products, or materials.

In accordance with various embodiments, the present disclosure relates to a system that is inherently flexible so as to support or accommodate different material treatment streams, for example, influenced or governed by different material treatment protocols, such as those implemented or imposed by different jurisdictional regulators, monitors or oversight bodies (e.g. in different jurisdictions). Furthermore, cloud- or web-based embodiments, as described herein, may also allow for multi-tenant implementation (i.e. support multiple customers), which may be more cost effective and/or easier to manage than single-tenant/single-use solutions. Rather than being designed for a specific customer, but instead for proper recycling reporting and management workflow, a single digital and networked platform is readily functional for and able to meet the needs of most customers without modification. Such a platform may therefore herein be referred to as “material-agnostic” or “jurisdiction-agnostic”, thus providing a highly flexible global material treatment, i.e. recycling and waste management, tracking platform that can report on and ensure compliance with distinct jurisdictional regulations. Notably, embodiments of the present disclosure can address certain drawbacks of known solutions, wherein materials subject to any jurisdictional treatment (e.g. recycling or waste management) requirements can be tracked, reported on and overseen by many or all relevant parties within a single flexible, robust, and easily managed platform. In yet other embodiments, multiple software or hardware instances of the material management platform may also be deployable, wherein each software or hardware instance of the platform in turn enables participation by any number of users or user types in any number of configurable/customizable material management instances.

Providing additional functionality and ease of use, in accordance with some embodiments, the platform herein described may be implemented as a Software-as-a-Service (SaaS), enabling continuous feature updates, performance improvements and bug fixes to the main software line that can automatically role out to all users. Such updates may be transparent to the user, and/or automatically applied such that they are simply present upon a user opening the application, with no need for manual installation.

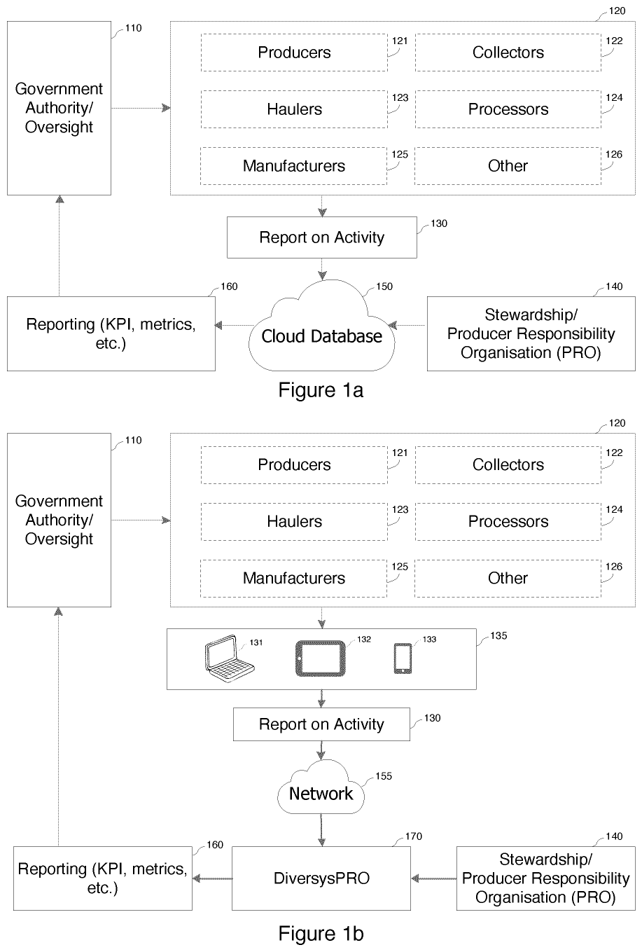

With reference to FIG. 1a, and in accordance with one embodiment of the disclosure, an exemplary process by which material treatment such as waste and/or recycling management may be implemented, will now be described. Within a given jurisdiction, an oversight committee, governing body, or the like, represented in FIG. 1a with the numeral 110, is responsible for ensuring that the treatment of waste is consistent with laws, regulations, and/or policies. Users 120 of the processes or systems herein described, such as material producers 121, collectors 122, haulers 123, processors 124, manufacturers 125, or other parties 126, such as consumers, may be responsible for reporting on activity relevant to such regulation, represented by the process step 130 in FIG. 1a. Such reporting may be related to, for instance, the specific types of materials used or handled, the respective quantities of such materials, or any transactions that occur whereby a material has been exchanged with another user. In accordance with various embodiments, such reporting is performed within an instance of material management (i.e. a digital representation of a material or material waste stream) configured for a particular material and/or product within a digital cloud- or web-based database 150 residing on one or more servers to which all users have access via an internet protocol. In addition to reporting on activity by a user in possession of a material, instances of material management within the database may also be accessible to and/or created by users responsible for reporting and managing obligations pertaining to said material management, such as a producer responsibility organisation (PRO) or a stewardship, represented in FIG. 1a by item 140. In at least one exemplary embodiment, a PRO user may first configure application and/or transaction templates within an instance (e.g. digital material management stream) with fields relevant to a particular waste or material treatment stream for which they have stewardship which can later be completed by another user(s).

As will be appreciated by the skilled artisan upon reference to the following description of illustrative embodiments, different users or participants may be considered depending on the application at hand, materials, products and/or treatment processes involved, and/or jurisdiction in which a particular instance is to be implemented. For example, some instances may be established, managed and/or regulated by a governmental or appointed oversight entity, with relevant industry and material treatment participants prescribed to participate and interface with the instance in accordance with such regulated use and configuration, whereas other instances may be wholly established and regulated by a particular industry or corporate entity, for example, within a given jurisdiction or again globally within the context of a multinational initiative, without necessarily invoking an oversight or jurisdictional entity. Given the versatility and flexibility imparted by different embodiments of there herein-described solutions, such contextual, jurisdictional and industry-related considerations may be readily applied.

Continuing with the example illustrated in FIG. 1a, upon material and/or regulatory data entry, material management reporting can be performed, either automatically by back-end algorithms or by a user such as a stewardship 140, to a relevant party or parties, such as a government authority or oversight committee 110. Examples of reporting may include any number of key performance indicators (KPIs), which may include, but are not limited to, metrics such as a demolition recovery index, a new build recovery index, chemical emission rate per facility, electronics sub-sector indicators, percentage of hazardous material over total waste, discharge efficiency, cost per load, percentage of waste diverted from landfill and other disposable options, percentage of waste recycled off- or on-site, percentage of reusable material, energy indicators, facility saturation rate, percentage of sample failure, compliance with water license conditions, energy indicators, pollution indicators (emissions to air, effluent, solid waste), potable water consumption, segregation rate, surface runoff efficiency, waste cost per project, waste generation per project, wastewater discharge, renewable energy consumption, emissions to water, or the like. Such reporting may be performed continuously, automatically upon data entry, or at prescribed intervals, depending on the application and/or jurisdictional requirements.

FIG. 1b schematically illustrates, in accordance with another embodiment, interactions between various participants in a material management waste stream process. Similar to FIG. 1a, an authority 110 may provide regulation and oversight related to the responsible treatment of materials of the waste stream. Users 120, which may comprise, for instance, a single consumer, an employee, an organization or company, a governmental entity, a representative thereof, or the like, may contribute to an instance within a material management platform 170 (e.g. DiversysPRO) using a device 135, such as a computer 131, a tablet 132, a smartphone 133, or the like. Via device 135 or an application associated therewith, data may be reported 130, via a network 155 (e.g. over the internet), regarding any activity related to the waste stream (e.g. a transaction of a material in the waste stream). The stewardship or PRO 140 responsible for the particular waste stream may, in accordance with some embodiments, have configured the waste stream type within the platform 170 based on the particular requirements of each waste stream being managed. The platform 170 may, upon receipt of material or stream data, provide reports 160 related to the instance of waste stream. Such reports may be, for instance, automatically generated based on the configuration of a particular waste stream managed within the platform 170.

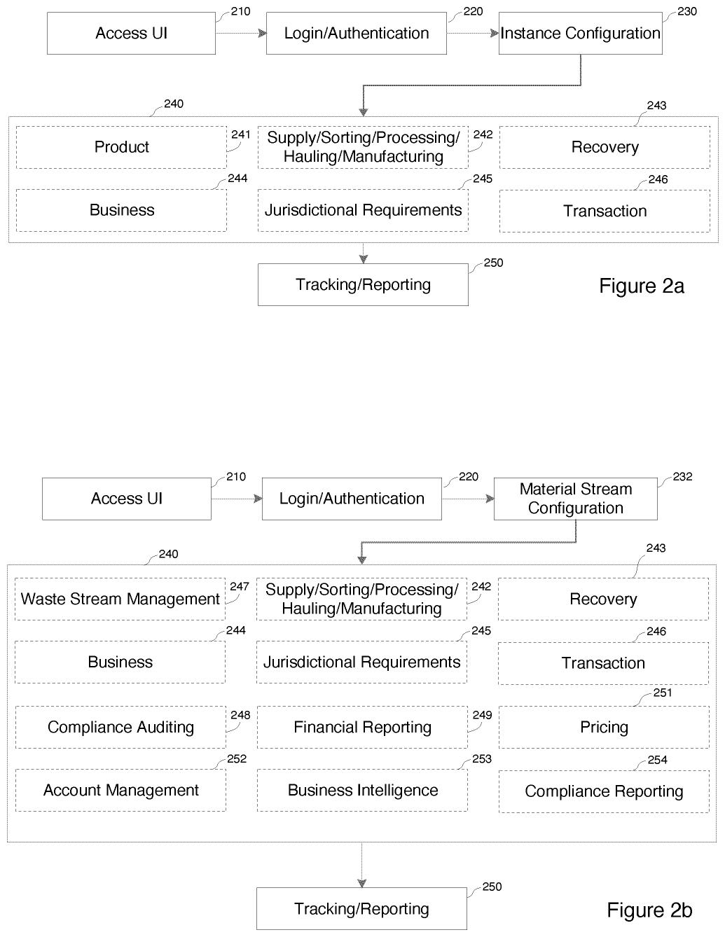

Enabling a versatile, flexible waste management platform may be achieved, in accordance with at least one embodiment, via the input of relevant information within an instance of waste management within a cloud-based database that may be tracked, monitored, updated, or analyzed by any relevant and/or authorized party. FIG. 2a, in accordance with such an embodiment, depicts a workflow process of generating and tracking a waste management instance via a user interface (UI) flexibly configured for receiving as input data relevant to a wide range of applications within any jurisdiction.

With respect to FIG. 2a, such an instance may first be initiated by a user accessing a UI, depicted as step 210. A UI may be accessed via a web browser or directly via an internet protocol, downloaded as an application, or the like, and may be a graphical user interface (GUI), or any means by which relevant material and jurisdictional data may be entered digitally. Such a UI 210 may be accessible by any appropriate electronic device, such as a mobile phone, laptop, computer, or electronic system with the ability to connect to the internet.

Once the UI 210 is accessed, a user may be required to perform a login procedure 220. Such an authentication step may be performed by any means appreciated by one skilled in the art, examples of which include, but are not limited to, the entry of a username and password, tapping one or more icons, swiping a specific pattern, entering a security credential, possessing a security token, scanning a barcode or QR code, or entering a biometric signature or combination of biometric signatures, examples of which include, but are not limited to, a fingerprint, a heart rate, an electrocardiogram signal, skin crease pattern, hair pattern, or the like.

Flexibility of a waste management platform system, in accordance with at least one embodiment, may be achieved by an instance configuration step 230 which customizes an instance for a particular material, good, product, and/or constituent materials. Instance configuration may comprise the entry of data 240 by a user, such as information related to the product or material itself 241, any appropriate information related to the supply, sorting, processing, hauling, or manufacturing of said product or material 242 (including information on or about some, any or all constituent materials and the treatment thereof), the recovery and/or recycling of said material 243, data related to any number of businesses or organizations involved in management of waste or recycling of said material 244, any jurisdictional requirements related to said material 245, and any transactions 246 that occur, whereby ownership, possession, or responsibility of said material has been transferred between any relevant parties or users. Any tracking, monitoring, or subsequent reporting on said material data may then be performed by a user, or performed automatically, either continuously or at periodic intervals. Further detail on data entry 240 and examples of information pertaining to items 241 to 246 are described below.

Further, and in accordance with another embodiment, FIG. 2b schematically illustrates another workflow process for generating and tracking a waste management stream or waste management instance via a UI. In this example, the digital waste management stream is again flexibly configured 232 by, for instance, a PRO user, for receiving as input data relevant to a wide range of applications within a jurisdiction. In this embodiment, the flexibility of a waste management platform is illustrated by the configuration of the waste management stream which allows for, for instance, management of the waste management stream itself 247, or user accounts or permissions 252 related thereto, and compliance auditing 248 that may be performed, for instance, by an oversight committee, or reported on 254 by the platform. Further, financial reports 249 may be accessed by or sent to any relevant participants, as may be information related to material or transaction pricing 251. Furthermore, various embodiments may further relate to the platform having access to digital analysis processes, such as artificial intelligence systems, that may assess any data 240 associated with a waste stream to determine any correlations, or to provide recommendations, such as those related to efficiency or business management 253 of the waste stream.

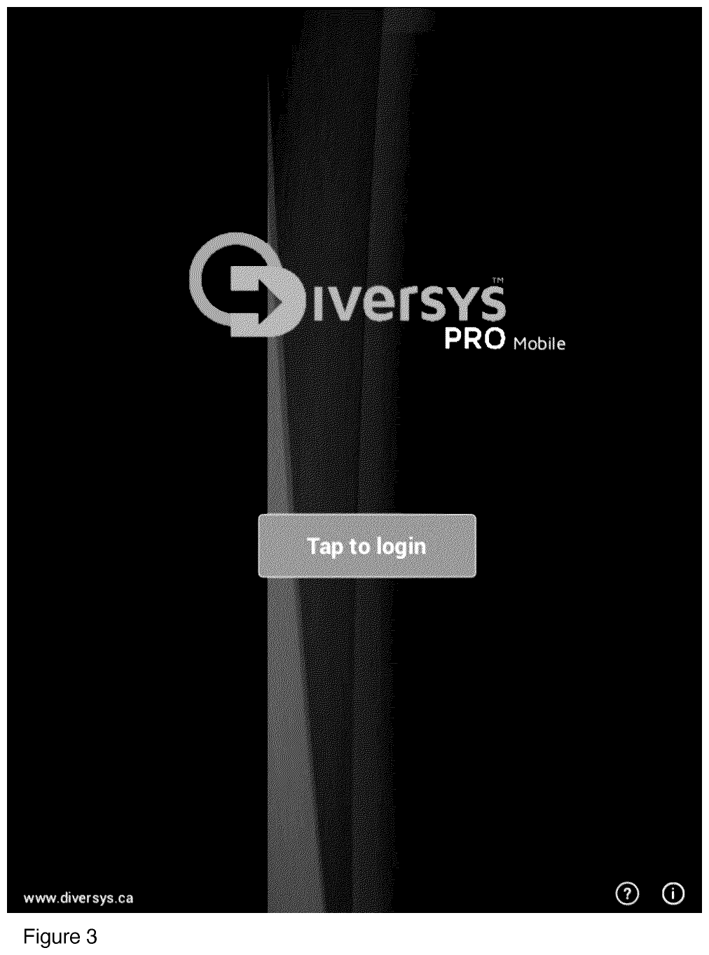

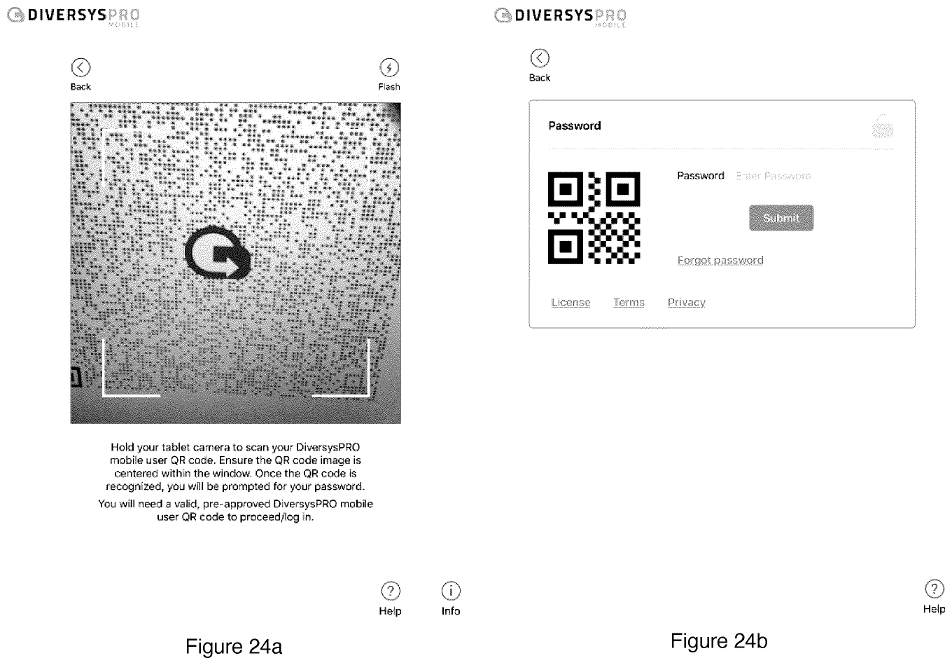

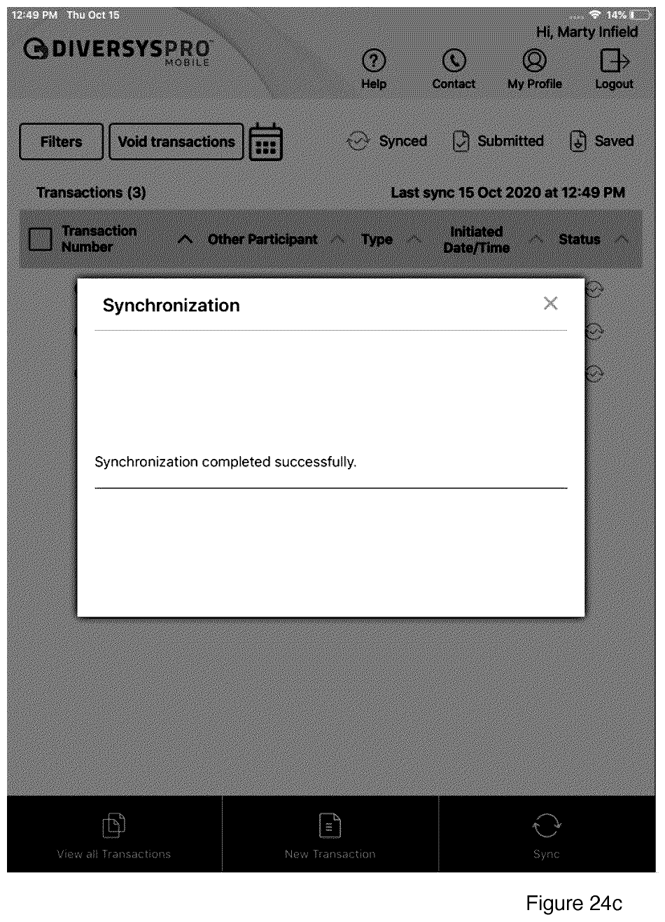

A non-limiting example of the steps of accessing a UI 210 and performing a login 220 is depicted in FIG. 3. In this example, the UI may be downloaded as a mobile application, which is accessed on a mobile device. In this example, a user is prompted to perform a login step by tapping an icon. Subsequent authentication steps may be additionally performed, such as by prompting the user to then enter a username or password or scan a QR code. For instance, and in accordance with one embodiment, FIGS. 24a and 24b show screenshots illustrating one exemplary login process. In this example, upon launch of a mobile digital application associated with a material management platform, a user is prompted, as shown in FIG. 24a, to scan, via a camera associated with the mobile device, a user QR code. Upon successful receipt of the user QR code, the platform then provides a second prompt via the mobile application, as shown in FIG. 24b, to enter a password associated with the user QR code to complete the login. Upon successful login, in accordance with some embodiments, the digital application may, for instance, access data related to the user account from the material management platform. For instance, FIG. 24c shows a screenshot indicating that content from the user account has been synchronized with data accessed by the platform related to transactions completed or in process that are associated with the user ID. The skilled artisan will appreciate that such processes may be performed upon login, may be periodically or continuously performed, for instance while the user is logged in, and/or upon demand by a user of the platform (e.g. upon tapping a “synchronization” button on a user interface), by any means known in the art.

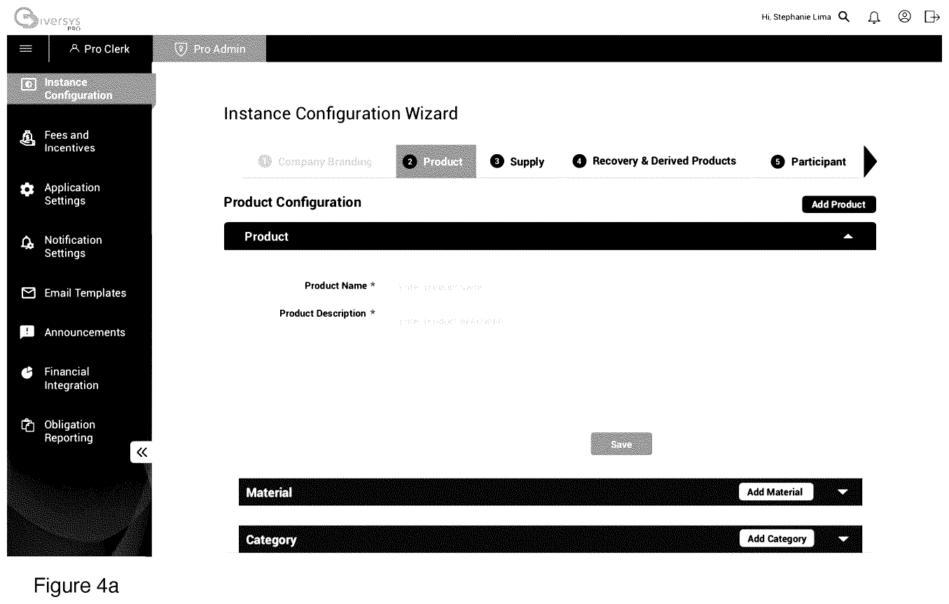

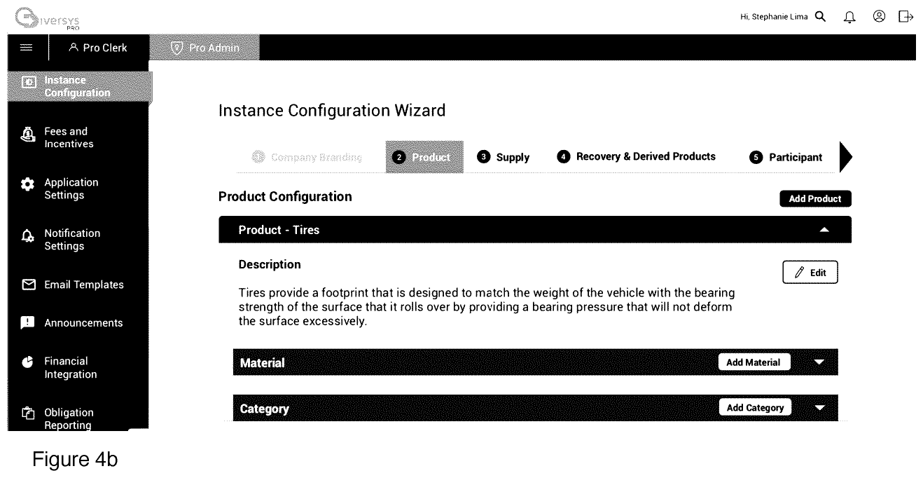

FIGS. 4a and 4b show an example of a GUI that may be employed to configure an instance of material management. Depending on the level or authorization or requirements for a particular user, one or more GUI displays may be presented, or the choice of displays presented to the user. FIG. 4a shows an example in which two displays are provided as options that correspond to a “PRO Clerk” and a “PRO Admin” user. The following description relates to an example in which a “PRO Admin” user may enter data to configure a material management instance within an “Instance Configuration Wizard”. Other users or GUI displays may be optionally provided with any number of similar input functions, or may provide fewer or more options for data entry. Other utilities of the GUI may include, but are not limited to, recording information related to fees and incentives, customizing settings of the application, including notifications, providing templates for communication, displaying announcements, integrating financial information, and/or reporting on obligations.

Depicted in FIG. 4a, and in accordance with at least one embodiment, a user may be offered the ability to configure a material management instance by entering information related to a particular product, such as the product name and a corresponding description. FIG. 4b shows an example in which a product name and description have been entered for a tire. The user may be given the option to save this information, either temporarily or directly to a material management instance in a database.

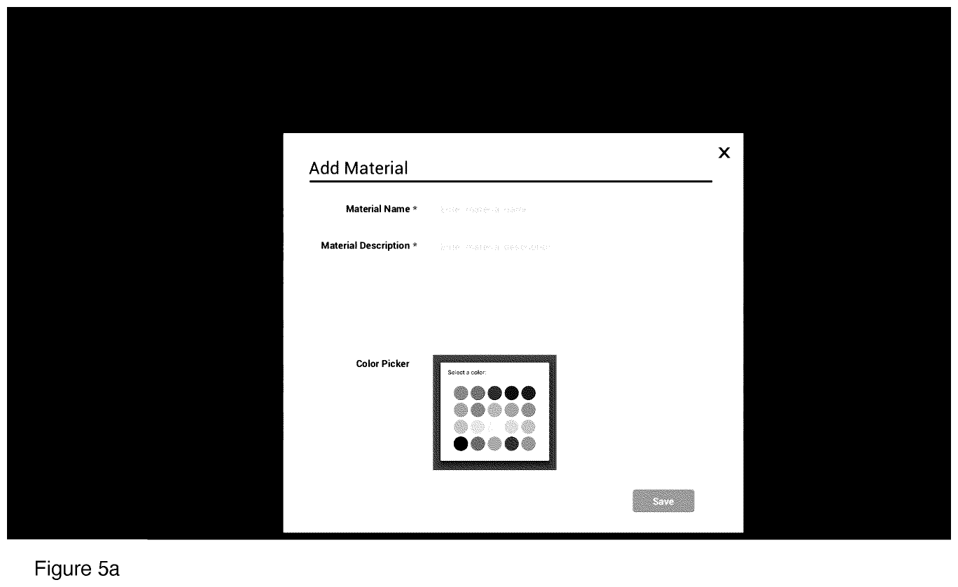

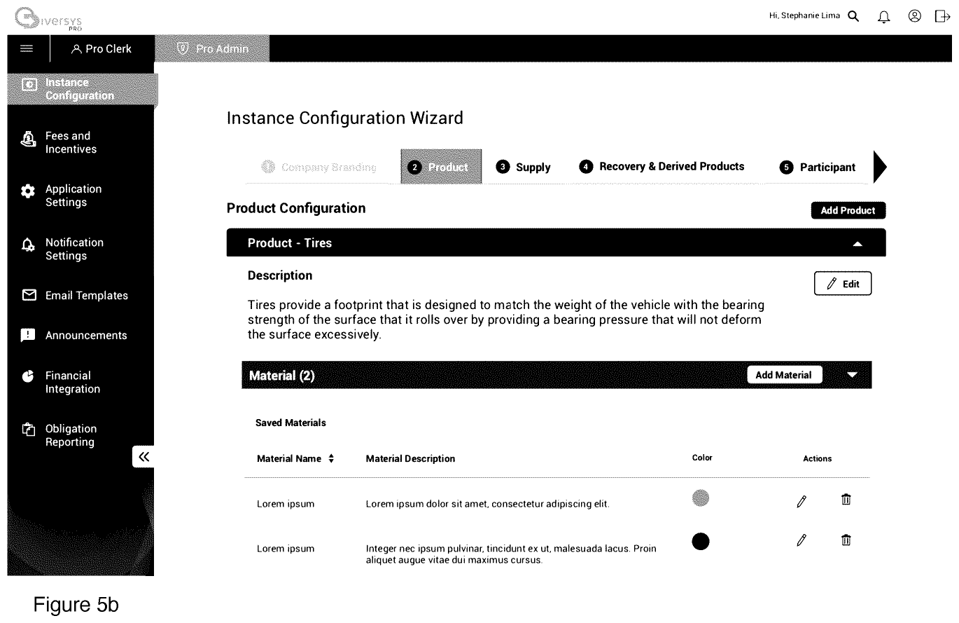

FIG. 5a shows an example, in accordance with at least one embodiment, of how a user may describe a product by including information about its constituent materials. In this example, a user may add any number of material names and descriptions, and assign other properties such as a display colour for additional ease of differentiation, sorting and/or visualization. FIG. 5b shows an example in which the tire product described in FIG. 4b may be further described by two rubber materials. In accordance with one embodiment, the ability to subsequently edit material information may be provided.

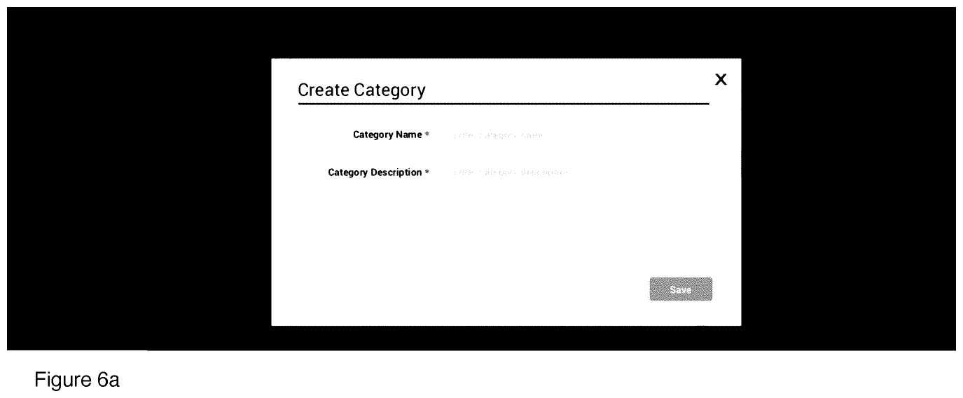

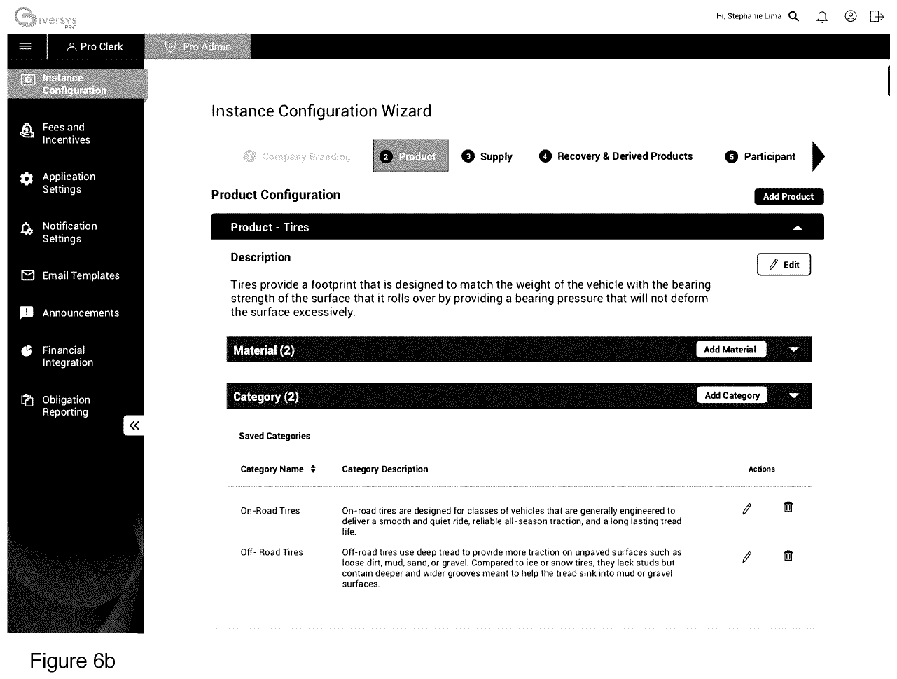

FIG. 6a shows an example, in accordance with at least one embodiment, of how a user may additionally categorize products and/or materials. In this example, a user may add any number of category names and descriptions. FIG. 6b shows an example in which two categories, on-road and off-road tires, have been described. In accordance with one embodiment, the ability to subsequently edit category information may be provided.

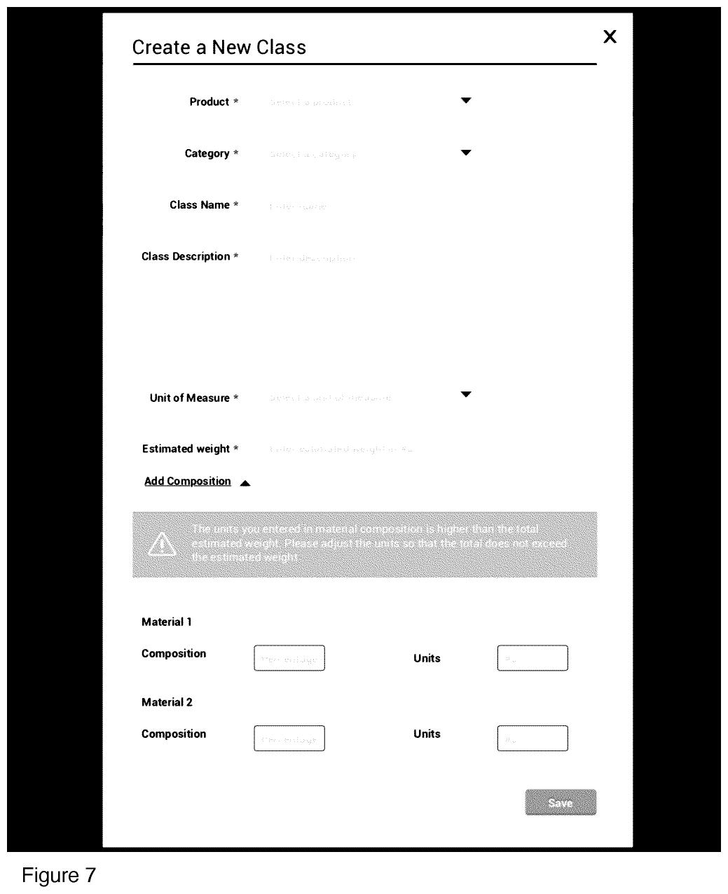

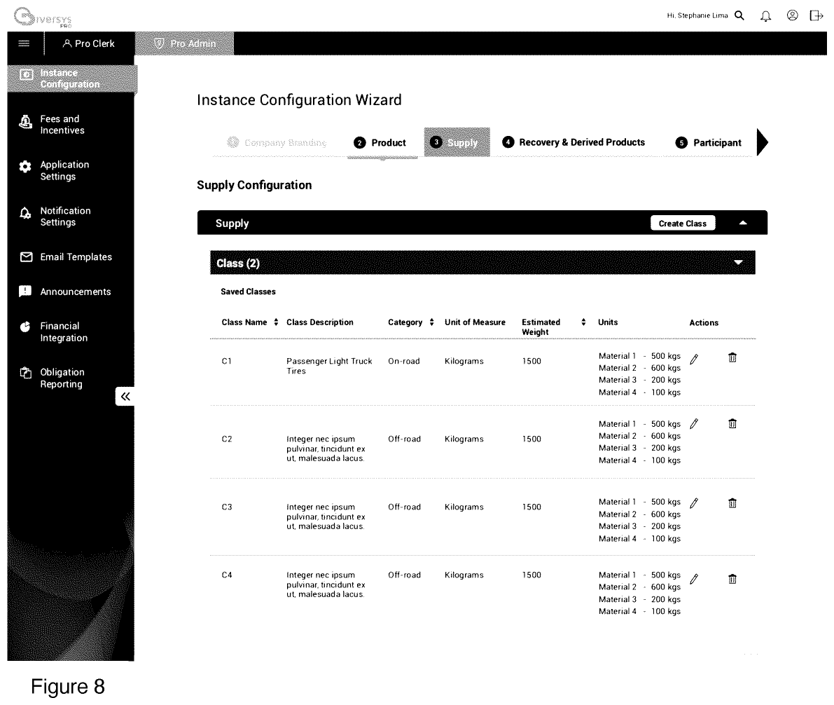

FIG. 7 shows an example, in accordance with at least one embodiment, of how a user may create any number of classes corresponding to certain products and/or materials. In this example, a user may input information such as a class name and description that is associated with a product name and category, and may assign properties such as units of measure and/or estimated weights. A class may further be divided into composite materials, with the option to assign independent units to said materials. FIG. 8 shows an example in which four classes have been created corresponding to different categories of on- and off-road tires, with their associated estimated weights, with each class comprising four different materials of various weights. In accordance with one embodiment, the ability to subsequently edit class information may be provided. Class information may optionally be provided in a separate tab within the GUI for ease of use, providing access to different users with varying levels of authorization, improved categorization, and/or more efficient or streamlined data entry and/or analysis. In this example, class information is entered in relation the “Supply” of a material management instance.

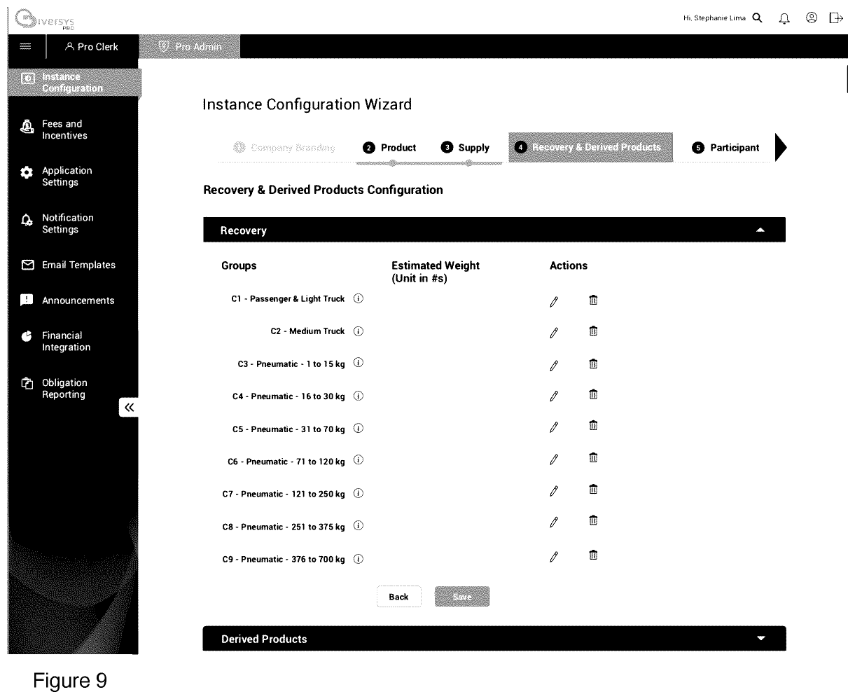

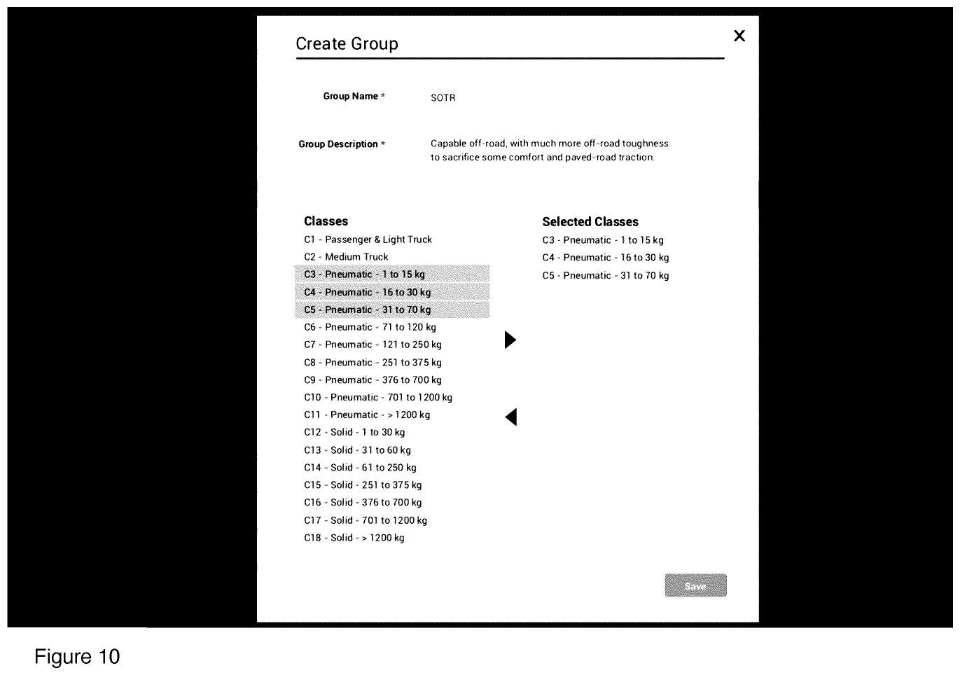

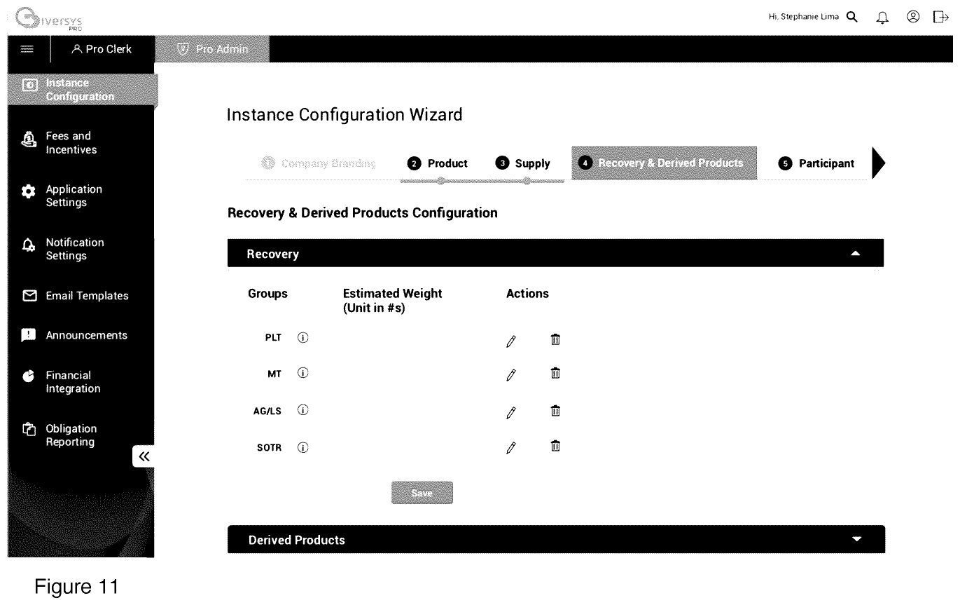

FIG. 9 shows an example, in accordance with at least one embodiment, of how a user may configure an instance to include information related to product derivatives and recovery. In this example, nine groups of products have been entered that may be relevant to product recovery, with the ability to provide associated weights. Versatility and simplicity of use of the platform for a wide range of applications may be integrated through, among other features, the ability to customize such groups. For instance, FIG. 10 shows an example in which groups may be created out of existing classes by simply clicking to select the corresponding items, with the ability to name and describe the resultant groups. FIG. 11 shows an example in which the nine examples of products/classes described within the recovery and derived products section of the GUI from FIG. 9 have been efficiently reduced to four groups of products.

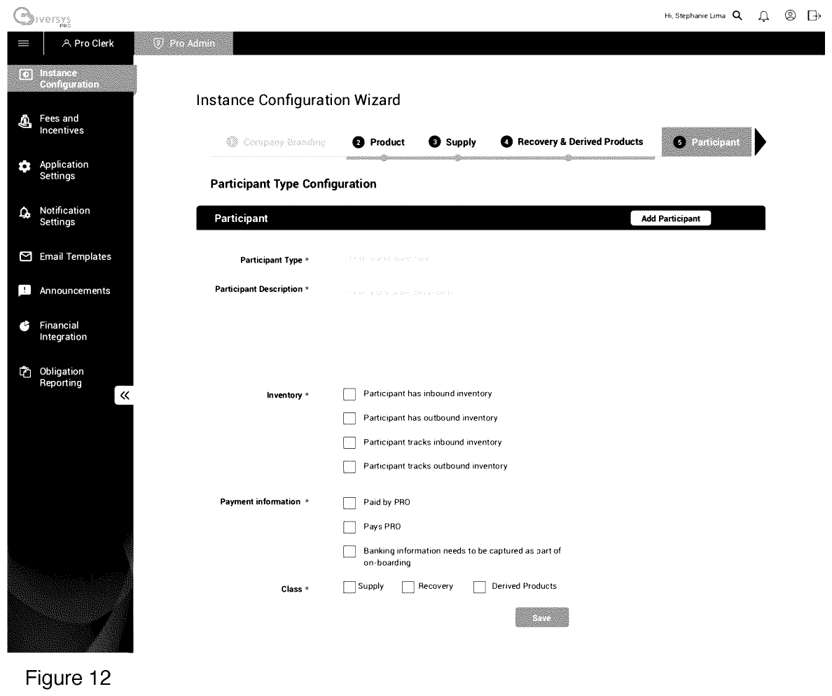

FIG. 12 shows an example, in accordance with at least one embodiment, of how an instance of material management may be configured to include information related to a user or participant in said instance. While the scope of information in this example is not an exhaustive list, and may include alternative or additional entries, in this example the GUI displays and can receives as input fields related to the participant type (e.g. producer, hauler, etc.), an associated description, whether any related inventory is inbound or outbound, payment information (e.g. whether or not a PRO or stewardship gives or receives payment), where and/or when such payment will occur, and whether the class of the participant is related to the supply, recovery and/or derived products associated with the instance.

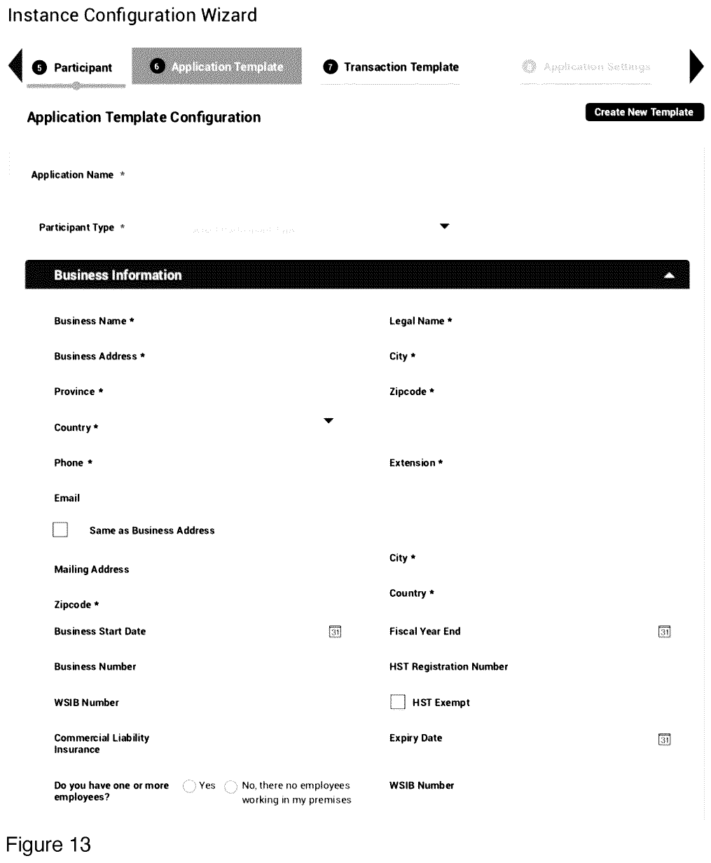

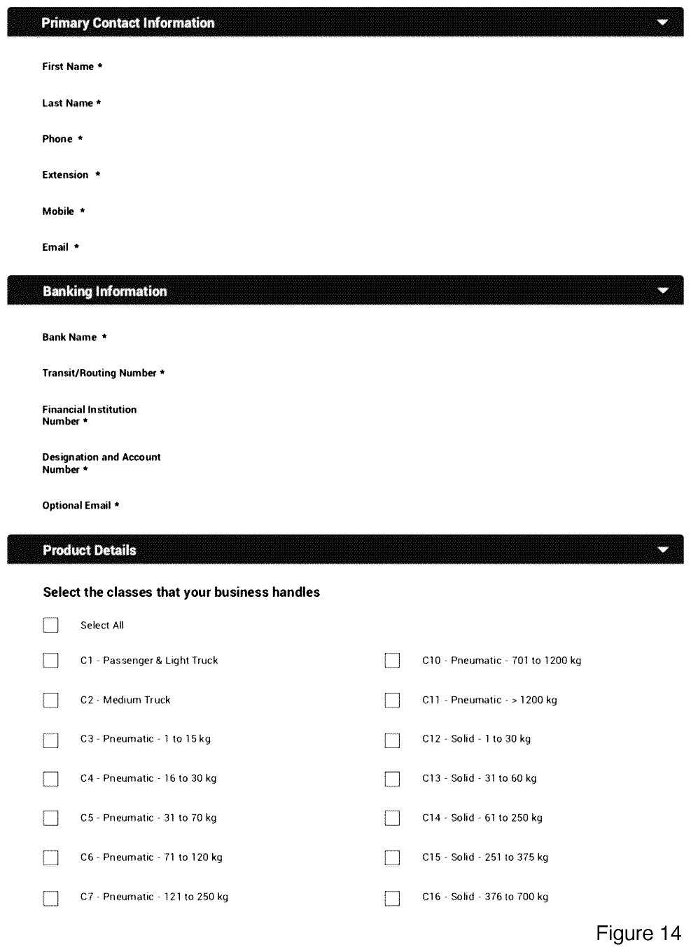

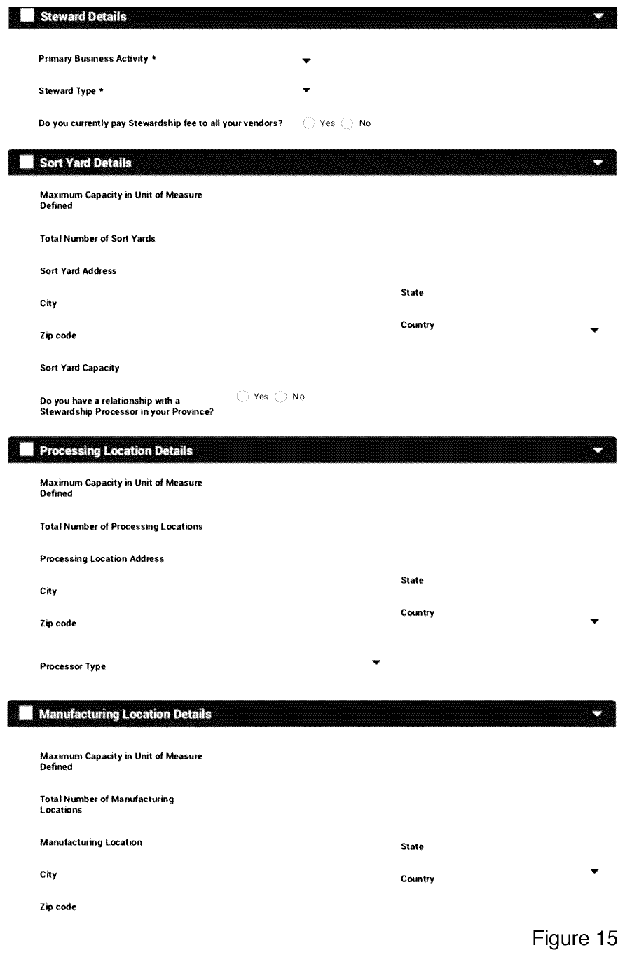

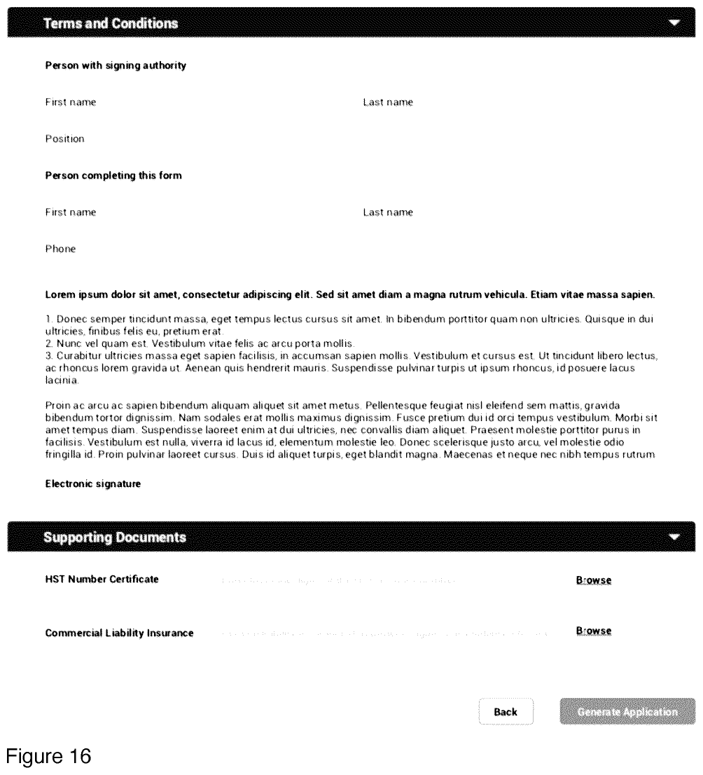

FIG. 13 shows an example, in accordance with at least one embodiment, of how an instance of material management may be further configured to generate application templates. In this example, an application can be named and the type of participant may be specified. A non-exhaustive list of information that can be provided as it relates to a particular user, participant or business associated with the instance is shown in FIG. 13. Similarly, examples of data that can be entered for an application template as it relates to primary contact information, banking, and product details are shown in FIG. 14, while FIGS. 15 and 16 show exemplary fields for the input of information related to, respectively, stewardship, sorting, processing and manufacturing, and terms and conditions and supporting documents.

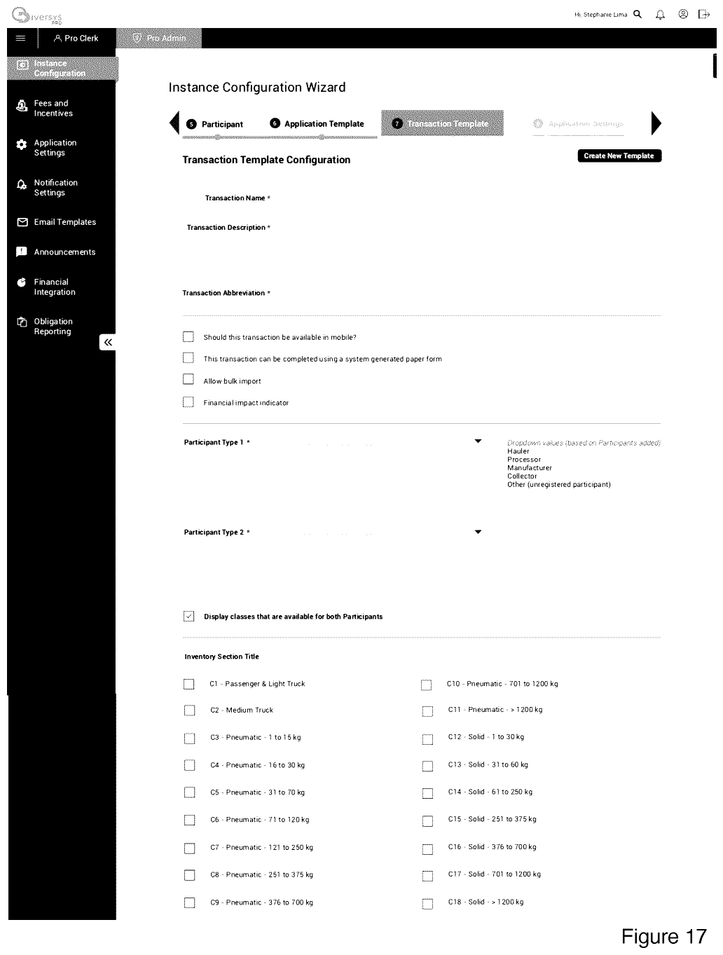

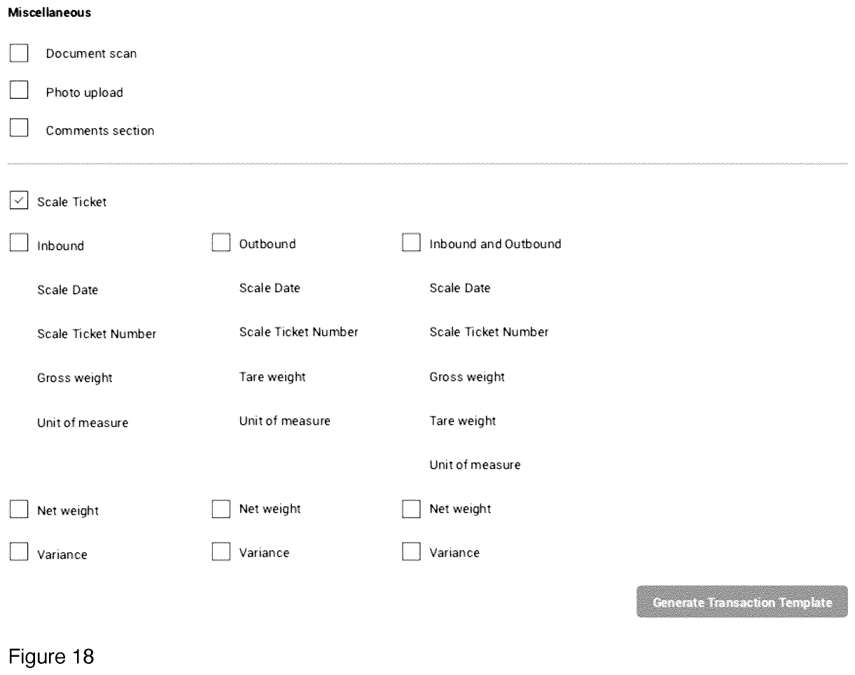

FIG. 17 shows an example, in accordance with at least one embodiment, of how an instance of material management may be further configured to generate transaction templates. In this example, a transaction can be named and described, with the method and type of recording selected by clicking on the UI, with fields for further description of the participants involved in the transaction provided. Such a template may allow for the selection of inventory involved through a simple series of clicks. FIG. 18 shows further examples of information than can be provided via a UI as it pertains to the processing and recording of a transaction.

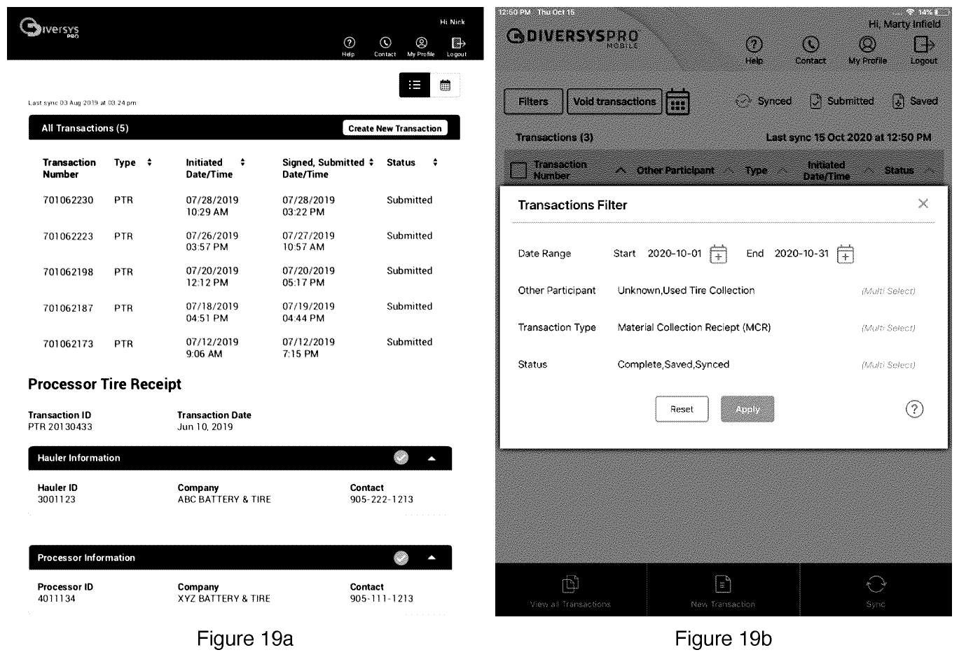

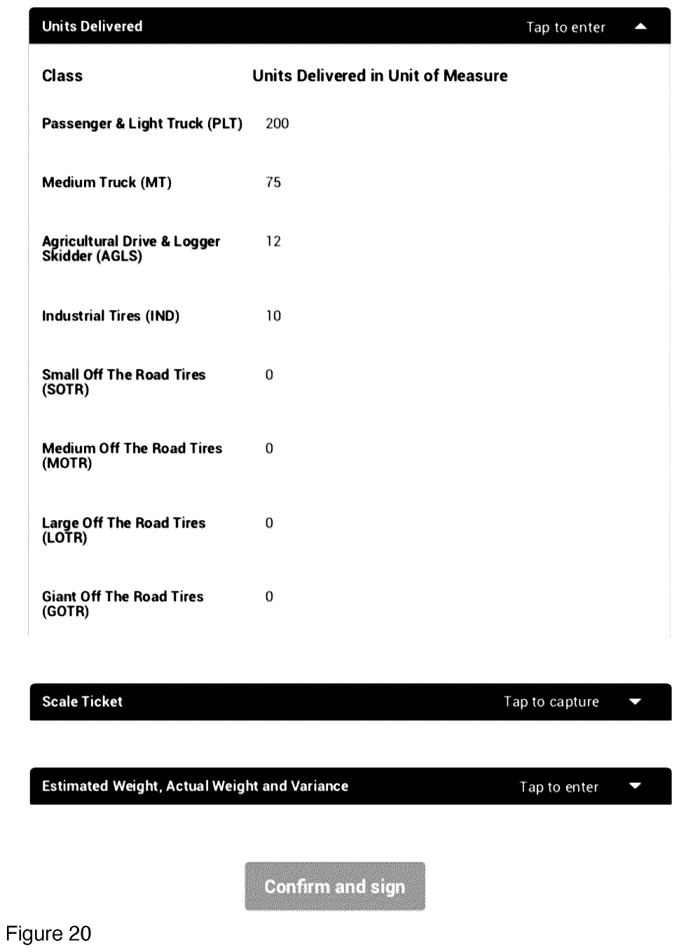

FIG. 19a shows an example, in accordance with at least one embodiment, of how an instance of material management may be tracked after configuration. In this example, a mobile device, such as a single purpose or multipurpose smartphone, laptop, tablet, or like mobile communication device, is used to access a GUI that displays a history of transactions within an instance of material management. Information displayed may include, but is not limited to, transaction numbers, types, dates and status. Receipts for transactions or other events within an instance may also be provided, such as those for hauling and processing, as shown in FIG. 19a. In accordance with some embodiments, transactions may further be sorted or filtered, as shown in FIG. 19b, for, for instance, ease of use. Accordingly, digital applications such as those on a smartphone or the like may, in some embodiments, access data stored on (or accessible to) a material management platform by various application programming interfaces (APIs) known in the art. Further, such transactions may, with appropriate permissions, be edited, entered, and/or recorded directly within a GUI, for instance, directly on a mobile device, as shown in FIG. 20, where examples of input information related to the units delivered, tickets, and estimated and actual weights and associated variances are depicted.

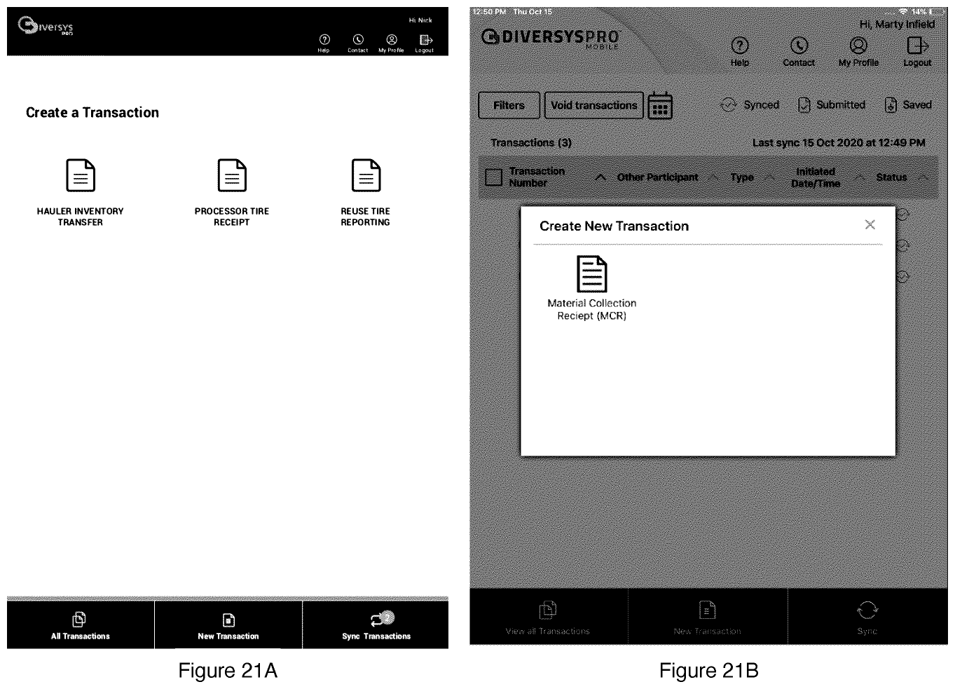

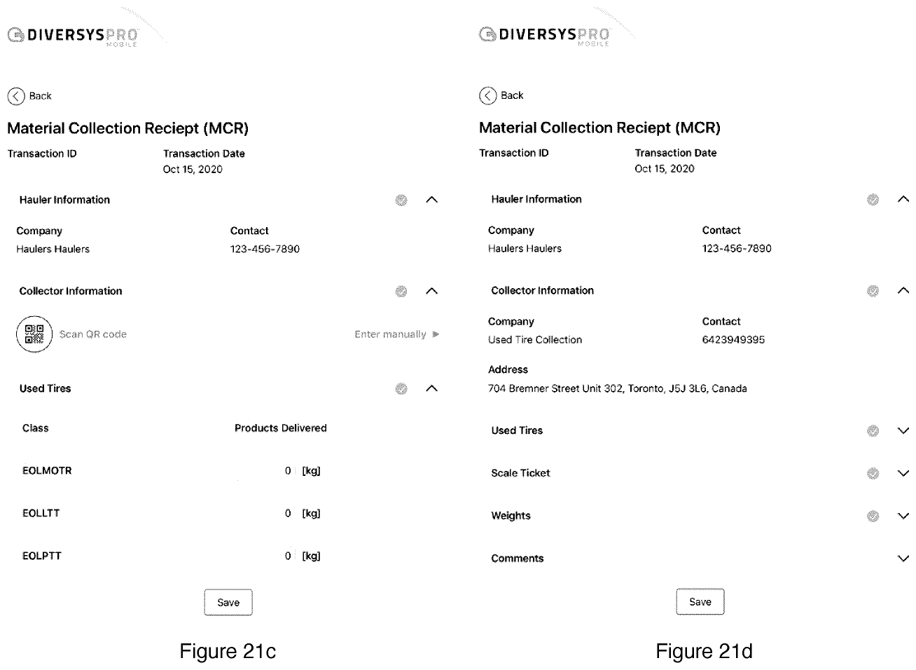

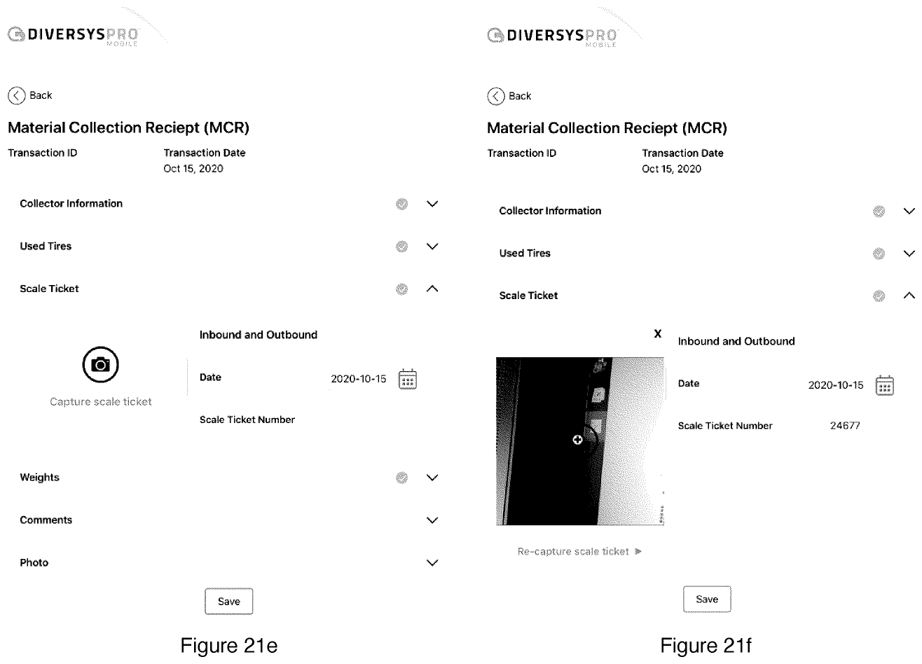

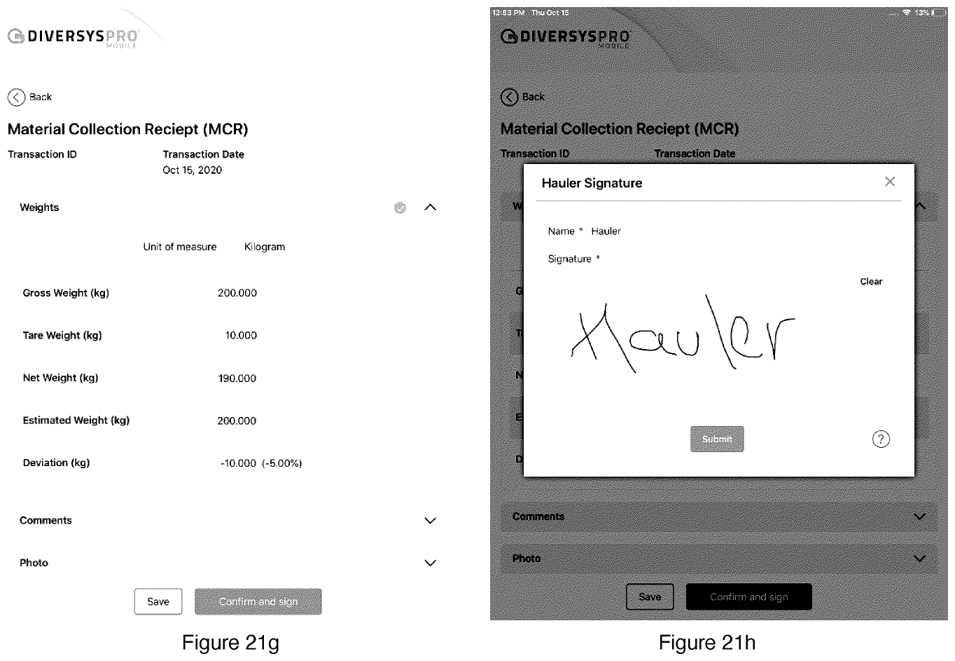

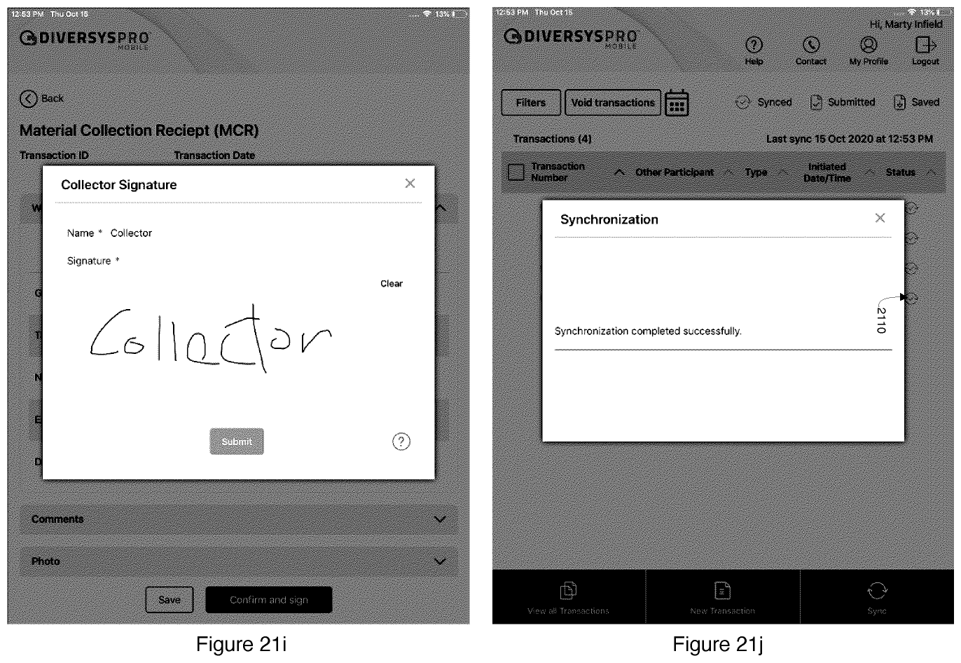

FIGS. 21a and 21b show examples, in accordance with various embodiments, of a UI, in this case on a mobile device, that allows for tracking, generation, organization and access to information related to transactions within material management instance. In the example of FIG. 21a, tabs at the bottom of the UI allow a user to toggle between displays corresponding to all transactions, the generation of a new transaction, and the syncing of transaction data with a database. For such an application to serve as a convenient suite that allows for complete management of one or more instances of material management, an application and/or GUI may also provide the user with, in accordance with at least one embodiment, the ability to quickly toggle between tabs and information relevant to a material management instance, including, but not limited to, his or her profile, access contact information, seek help, or log out, as depicted in the top portion of the UI of FIG. 21a.

In the example of FIG. 21a, a display corresponding to the creation of a new transaction is shown, with options illustrated as icons for creating a hauler inventory transfer, a processor tire receipt and a report on the reuse of tires, in accordance with one embodiment. In accordance with various embodiments, however, and highlighting the versatility of such a platform for customising a material management instance and/or user profile based on, for instance, user roles or privileges, the UI for a different user (e.g. a material collector), shown in FIG. 21b, displays an icon enabling the creation of a material collection receipt.

In accordance with various embodiments, FIGS. 21c to 21j are screenshots showing exemplary user interface forms and display screens for entering data related to such a material collection transaction in order to generate a receipt within the material management platform (and therefore allow any other authorized users to access the receipt). While these examples relate to collection of materials, the skilled artisan will appreciate that various embodiments may comprise other forms and/or interfaces to record data and/or provide receipts related to other forms of transactions, without departing from the general scope and nature of the disclosure. Such forms may allow the user(s) (e.g. the hauler) to enter information related to their organisation, such as a company name and contact information. In some embodiments, such information may already be accessible to the platform, and may, for instance, be automatically loaded into a form if a user has been authenticated and identified on a device. For instance, the platform may recognize a user logging in as a hauler, resulting their information being automatically appropriately entered into a collection receipt, as shown in FIG. 21c. Alternatively, or additionally, company information may be loaded upon, for instance, scanning a QR code or other identifier, as shown in FIG. 21c. In this embodiment, the user (e.g. hauler) may manually enter information related to a collector in a transaction, or may scan a QR code associated with the collector to populate the relevant fields. FIG. 21d shows a screenshot following semi-automatic entry of collector information following scanning of a QR code associated therewith. Such ease of tracking and functionality, in accordance with some embodiments, may facilitate tracking of materials, ultimately providing, for instance, increased performance, accountability, adherence to guidelines, reporting, and the like, of the management of materials.

In accordance with another embodiment, FIG. 21e shows a similar collection transaction receipt-generating form on a UI. In this example, the material collection receipt generation UI provides the ability to capture an image of a scale receipt. FIG. 21f again shows this UI after capturing an image (which in practice may comprise an image of a scale ticket), wherein the inherent simplicity and generality of the process again facilitates the tracking of data related to material management. FIG. 21g shows further data entry forms related to the tracking of materials through a transaction between a hauler and a collector. In this example, data entry forms include fields related to the weight of a material, as well and comments and/or an image of the material involved in the transaction. In accordance with some embodiments, the UI may also prompt participants in the transaction to each provide a signature, as shown in FIGS. 21h and 21i. Upon completion of the entry of any necessary data, images, authorisation signatures, and the like, a transaction receipt may be submitted to the platform. In accordance with some embodiments, submission of a new transaction within a digital application may initiate a synchronization process, wherein data related to the transaction may be uploaded or otherwise synchronized with the material management platform. This is illustrated in the screenshot of FIG. 21j, where, in addition to displaying a notification in the foreground that synchronization of data within the mobile device and the material management platform has been successfully performed, a fourth transaction 2110 (the new transaction related to FIGS. 21a to 21i) is shown in the transaction list in the background, which did not exist upon synchronization at login in FIG. 24c.

As will be appreciated by one skilled in the art, FIGS. 3 to 21j illustrate examples of content that may be found in a UI in order to manage, track and report on recycling and waste (e.g. various material treatment) management. Such examples are not intended to be limit the scope of this disclosure, and any other relevant data entry may be incorporated within the framework of such a platform. For instance, similar digital forms for data entry may be present within the UI, an example of which is an “Obligation Reporting” tab, as shown in FIGS. 4a and 4b. Such additional tabs may allow for the entry of information related to, for example, jurisdictional requirements, metrics that are to be reported, and/or scheduling of such reports. The particular organization of such fields may additionally be customized based on a particular application. For instance, and in accordance with at least one embodiment, specific users may be granted access to subsets of the available material data. An example of such an embodiment may be that access to transaction data may be granted to all users except a consumer.

The flexibility, utility, and ease-of-use of such a platform may be further illustrated through various examples of its application, some non-limiting examples of which will now be described.

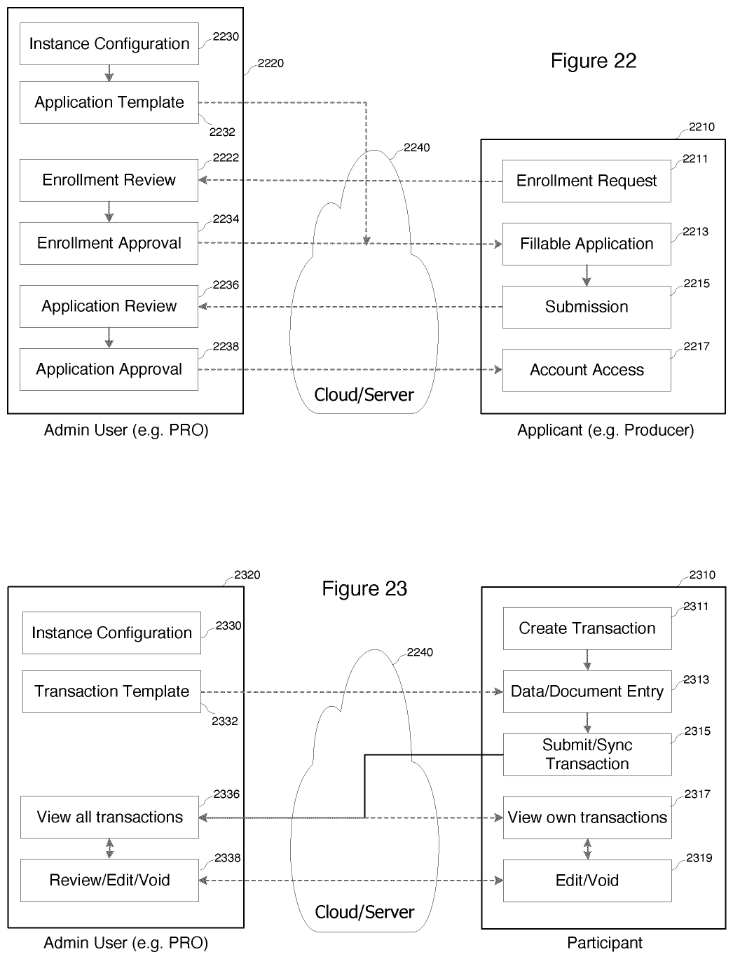

With respect to FIG. 22, a new material management application may be requested by a user 2210 such as an executive producer, a clerical producer, an executive service provider, or a clerical service provider. Said user can request a new application for the purpose of signing up with a desired PRO and enrolling as a participant in an instance of material management, the application template 2232 for which has been previously configured 2230 by a PRO administrative user 2220. Upon loading the UI via a mobile or web browser, the user 2210 may enroll 2211 in said instance using a valid email address and relevant information regarding participant type(s) and submit any requests. Information can then be sent back to the server 2240, with a confirmation of submission message displayed on the UI.

In accordance with at least one embodiment, the enrollment request 2211 may be reviewed 2222, either automatically by a server algorithm or by an admin user 2220. If enrollment is approved 2234, the user 2210 may then receive a link to an application 2213 generated from the application template 2232 at their email address. Fields enabled by the PRO can then be filled by the user, and appropriate documents uploaded. At any stage of filling in the required information, the option may be presented to save the application in its current form so that any information saved can be later retrieved by a user. Fields within an application may have built-in validation, an example of which is a validation rule of 2-digit numeric, that can be validated at the time of entry. Upon entry of all required information and supporting documentation, the application can be submitted 2215 by the user, for instance through the clicking of a “Submit” button, which can send the application to a PRO for review.

In this example, a PRO clerical user can then navigate within a UI to see a list of pending applications that include information such as business name, primary contact, participant type(s) and date of submission. The PRO user can then perform an action by clicking on the UI to, for instance, review, reject, approve, hold, or assign to another PRO clerical user any pending application.

During review 2236, various options may be available to a PRO user to, for instance, review records of an application, flag fields that are not approved, add notes, change the contents of various fields, and/or send the application back to the applicant. A rejection of an application may include the option to state any reason(s) for rejection. Approval 2238 may include the platform functionality of contacting the applicant for notification of approval and enable account access 2217. In this case, fields from the application may already be populated. Financial records may be integrated and/or QR codes may be created for the applicant, which can then be accessed by the applicant as a new, additional section within their account for completion and submission via a UI. In the case of an application being put on hold, application contents may be locked, preventing participants from modifying content, any expiry timer may be stopped, and a record status of “On Hold” may be displayed, for instance if a PRO user needs to verify and/or further investigate. Editing may additionally be enabled for a PRO user, whereby the PRO user is provided with an editing function/button to initiate changes to any applications listed. Any changes can prompt notifications to a PRO and/or applicant regarding said changes.

In accordance with at least one embodiment, an exemplary process of managing transactions will now be described with respect to FIG. 23. While this example includes description of creating, viewing, editing, voiding, reviewing, approving, and recording transactions, such steps are provided as various embodiments for illustrative purposes, and such description is not intended to limit the scope or functionality of a material management platform as described in this disclosure.

Creating transactions within an instance of a material management system may populate fields with data used to operate and perform business functions, and may, for some applications, be particularly relevant to infield service providers, and/or clerical producers, PROs and service providers, as designated generally as a participant 2310 in FIG. 23. Such users may have assigned to them the ability to log in to a web or mobile system (with, for instance, a username and password, or a QR code), role and permission to allow for the creation of a transaction (e.g. through a mobile application or web UI) and access to templates 2332 as generated and defined by an Admin User 2320 such as a PRO during an instance configuration. Transactions may be created 2311 by clicking/tapping a “Create New Transaction” or similar button or icon, whereby the user is then presented with a screen where he or she can tap to select the appropriate transaction template. Relevant fields may then be populated 2313, with the ability to save data at any time to be later edited as necessary.

In a situation where a document upload is required (e.g. uploading a scale ticket), tapping a field may present a camera UI for acquiring and/or uploading a picture of the document during step 2313 and perform any image processing (e.g. cropping, frame adjustment) required. The application may allow for the automatic detection of edges of the document, provide buttons for returning to the camera UI to acquire a new image, cancel the process to return to the transaction template, and/or accept the image for upload and populate any specified data fields as part of the document upload. Such photographs may be specified as inbound or outbound, and/or described with a scale date, ticket number weight and/or unit of measure. The process may be repeated for outbound tickets to complete data entry, with the ability to provide any tare weight. If both inbound and outbound tickets are included, data such as the net weight and variance may be calculated automatically by the application and displayed. In accordance with at least one embodiment, if the variance is equal to or larger than a variance threshold configured by a PRO admin during template configuration, the user may be required to capture a photograph and/or provide additional comment.

Upon successful population of all required fields, a user may be able to confirm, sign and submit a transaction 2315 by clicking the appropriate fields and/or buttons. If a signature is required, a UI may be presented for signature entry, which may include, in addition to a field for drawing a signature, fields for entering a first and last name, the option to clear any fields, and/or the ability to return to another page of the UI. Upon successful entry, the user may be taken to a summary or other page of the UI, wherein a confirmation screen with a transaction ID may be displayed, optionally with a button operable to sync the transaction with a server.

The ability to view a transaction that has been created, in accordance with at least one embodiment, may be applicable to one or more of a wide range of users, including, but not limited to, clerical producers, PROs, and/or service providers, admin producers, PROs, and/or service providers, third-party auditors, infield service providers, and/or an oversight compliance officer. The scope of view may be defined by the type of user. For instance, PRO admin or PRO clerical users may be able to see a list of all transactions 2336, while a clerical producer, service provider admin, or infield user may see a list of transactions in which they are a participant 2317. The latter set of users may additionally be able to see a list of their associated transactions in a calendar view. For some applications, an oversight compliance officer or third-party auditor may see a list of all transactions within a PRO instance of material management.

A web or mobile application may allow the user to navigate to a page which has all relevant transactions listed with appropriate information displayed, including, but not limited to, any one or more of transaction IDs, statuses (e.g. complete, incomplete, void), sync statuses, transaction types, transaction dates, sync dates, or participant account numbers. Upon tapping or clicking a transaction, the user may be taken to a page containing all or a subset of the relevant content, including transaction details, scale tickets and signatures. The user may additionally have the option to view transactions via a transaction menu or a reporting period menu. Within a reporting menu, the user may be able to navigate to a reporting period and be presented with a page displaying transaction types that affect, for instance, inbound inventory, outbound inventory, or both. Navigation to a transaction list may then present the user with data such as transaction IDs, statuses (e.g. complete, incomplete, rejected, approved, voided), mobile/web forms, transaction dates, sync dates, participant account numbers, inventory fields (e.g. classes, such as class 1, class 2, etc.), fee or incentive amounts, notes, and/or any information related to whether or not a transaction has been previously adjusted.

In accordance with at least one embodiment, a user with appropriate permissions, such as a clerical producer, clerical PRO, clerical service provider, or infield service provider, may be afforded the ability to edit transactions to, for instance, adjust transactions that were incorrect, incomplete, or require updates. Such ability may be limited to transactions that are not in a state that prohibits editing, examples of which may include, but are not limited to, “Complete on Mobile” or “Approved on Web”. Selecting a transaction to edit may be performed from a page such as that used for viewing transactions, as described above, which contains a button or icon that, when clicked, will allow the user to edit any fields associated with the transaction and save any changes, as in step 2319 of FIG. 23, with any validation rules still applicable and a record of any changes saved. Notifications of any changes may additionally be provided to any relevant users, and may include a link to the transaction with any changes highlighted for ease of approval or rejection via a respective button or icon. Edits may be recalled if, for instance, a user would like to recall any changes prior to said changes being accepted by another participant. This may be exercised in the form of navigating to the appropriate transaction within a UI, clicking a “Recall” or similar button or icon, and confirming the recall. This may result in edited fields being reverted to their previous values and further notification sent to any users impacted by the change(s).

In accordance with at least one embodiment, a user such as a clerical producer, PRO or service provider, or an infield service provider, may be able to void a transaction in order to, for instance, remove its effects from the system. A user with role and permission to do so may void already approved transactions through a web or mobile interface upon navigation from a page for viewing transactions, as described above. Once a transaction to be voided is selected by a user, details of the transaction may be displayed with the option to void the transaction by a button on the UI. A void can then be confirmed, whereby all inventory and payment effects of that transaction can be reversed. A notification of such an action can be sent to all relevant parties, with a link through which a participant can approve or reject the voiding of the transaction.

A user may also, in accordance with at least one embodiment, review and approve transactions, as in step 2338. For example, a PRO clerical user with role and permission to, for instance, create a transaction, may use a system herein described to review, approve, or invalidate a transaction that has been created. Conditions on such actions, such as a requirement that reviewable transactions may not be auto-approved, may be defined during the setup and configuration 2330 of a transaction. Functionality in such an example could be implemented in a similar fashion to editing a transaction, as described above, via a UI. Any reasons for rejection may be supplied in a UI field in a case where the transaction was rejected, and relevant users may be notified with any pertinent information.

In some instances, and in accordance with at least one embodiment, a hardcopy paper form may be generated to record a transaction. A non-limiting example of this functionality may comprise a user such as a clerical service provider, PRO or producer, or an admin service provider or PRO, generating a paper form from a transaction template if there is an issue creating a transaction on a mobile- or web-based UI. Such forms can be prepopulated with relevant participant information and may then be used by, for instance, an infield service provider for conducting transactions. In one embodiment, a user may only use a form number in a transaction that they generated themselves. Similar to the method described above of creating a transaction via a web or mobile UI, navigation within the UI to a screen where the user can select a transaction type can allow for the completion of fields indicating the number of paper forms to generate and the assigning of a unique form number for each copy. A form may have the same sections and fields that were created in the transaction template, and form numbers can be stored in a database for later validation against the paper form upon entry in the UI. In accordance with at least one embodiment, forms may be downloaded, for instance as a PDF file, and distributed to users for completion. They may be subsequently entered through a UI by clerical users using, for instance, generated form numbers for validation.

An example of a mobile application that a user may employ for managing materials, in accordance with at least one embodiment, will now by described. Any user, examples of which may include, but are not limited to, a clerical or infield service provider, a PRO admin, or a consumer user, may wish to create and edit transactions, for instance from a template created by a PRO admin during configuration of an instance of material management, on a tablet or mobile phone connected to the internet for the purpose of populating a PRO instance with transactions and data. A user may download the digital material management application from a website or app store, and can additionally be notified about any updated app versions which can be installed without loss of any data. Upon launch of the application, the user may be taken to a screen where they are presented with a way of scanning a unique QR code, for instance, to log in. Upon login, the user may be presented with the Terms and Conditions as defined by a particular PRO, which can be accepted. Unsuccessful login may prompt the user with a notification to that end.

With a mobile device connected to the internet, or again in the absence of an active network connection for applications previously configured via an appropriate network connection (e.g. for users operating or accessing the system in a cellular network dead zone and/or where access to a nearby Wi-Fi network is unavailable), the user may then initialise applications by launching the application and scanning their QR code and entering all configuration metadata, transaction templates, and other relevant setup parameters. Such information may sync with the instance of material management linked to the QR code or user account (either immediately and/or upon regaining access to a reliable communication network connection). The application may be configured such that inactive users may not complete transactions or create new transactions. Such a user may be notified on-screen within their mobile application.

Upon successful login, a user may be presented with a home page containing icons with functionality upon clicking to sync with a server, navigate to a transactions section for viewing, and create new transactions. Viewing transactions may include the ability to view all transactions on one screen, whereby specific details can be seen by clicking on the appropriate transaction. A user may then be able to edit or void incomplete transactions created by the user on the mobile platform. To create a new transaction, a user may, in accordance with at least one embodiment, tap a button on the UI to be taken to a screen with a list of pre-defined transaction templates that are configured by the PRO for that participant type. Such templates may be designated a respective icon and acronym, and may only be visible if flagged by a PRO with “Available on Mobile”, or the like for, for instance, security purposes. Upon clicking the desired template, the user may be taken to a page where they are presented with a blank transaction template of that type, which can be filled with data in accordance with validation, signed, and completed, for instance through clicking a “Complete” button.

Within a mobile application, navigation can be facilitated via the inclusion of a “Back” or “Home” button on all pages except the home page. A “Help” button may be provided on all pages to aid a user in learning how to use the app or seeking guidance.

In accordance with at least one embodiment, further description of exemplary user frameworks, including user management, roles and permissions, and workflow positions, will now be provided.

User management, in accordance with at least one embodiment, may be performed by PRO or Service Provider Admins. Management may include the ability to create new user accounts within an instance of material management and grant participant users and user accounts permission access to the system. A PRO staff user, which may include, but is not limited to, an executive, administrative, or clerical user, may have an associated username and password and any information necessary to configure user information within an instance of material management. A PRO Admin user, for instance, may be able to navigate to a User Management section of a material management system, whereby he or she may see a list of all PRO users within an instance of material management, such as in a UI page associated with “PRO Staff.” Fields corresponding to first and last names, email IDs, account creation dates, statuses (e.g. active, inactive, invite sent, invite expired, etc.), actions (e.g. edit, remove, reset password, inactivate, etc.), and the ability to add a user may be seen by the PRO Admin. It will be appreciated by the skilled artisan that appropriate functionality can be provided for any options available to the PRO Admin to manage participants such as other PRO Admins, or other user accounts such as producers, service providers, or other executive or clerical users.

Management users such as a PRO Admin or Service Provider Admin may, in accordance with at least one embodiment, have the ability to create user roles within an instance of material management for the purpose of, for instance, grouping a set of specific permissions to be applied to user accounts. Such a user may navigate via a UI to a page in which an instance is set up via selection and configuration of a matrix of menu items, screens and panels. An example of such a page may be accessed by navigating to, for instance, a “Roles and Permissions” page accessible from a “User Management” page. The user may then be presented with an option to “Add New Role,” or the like, wherein the user may enter fields within the UI corresponding to, for example, a role name and description, with the option to copy permissions from existing roles as displayed in a list that can be selected via a click. Assigning roles and permissions may be enabled via a screen in which all elements within an instance are presented, with the ability to expand any screens or panels. Such a screen may also comprise a section wherein the user can assign a Reporting Period Workflow Position or an Application Workflow Position to a role from a predefined list of positions, as described below. Existing user roles may be visible in respective rows of a UI, with information related to role names, dates modified, number of users, and any action options such as editing or removing. It will be appreciated by the skilled artisan that other management users, such as a Service Provider Admin, may have similar ability to manage roles, or may be provided more or less content that is viewable and/or editable. For instance, a Service Provider Admin may not be provided access to the subsection described above corresponding to assigning a Reporting Period Workflow Position or an Application Workflow Position to a role from a predefined list of positions.

Users such as a PRO Admin may be afforded the ability to, in accordance with at least one embodiment, set up and define workflow positions for the purpose of, for instance, routing applications and reporting periods through a required number of PRO clerical users. In one example, the PRO Admin user with all necessary information may configure reporting period workflow positions of an instance of material management by: creating positions, which may include navigation to a page where the user can create a new workflow position via clicking on the UI and entering fields corresponding to a position name (e.g. “Hauler Approval L1”, “Processor Approval L5,” etc.), description, and participant type (optionally via a dropdown menu of available participants); defining thresholds, which may include navigation to a “System Thresholds” page, or the like, wherein a section resides for each participant type with, for instance, line items within each section for each workflow position for each participant type, with the ability to enable/disable via a check box a corresponding threshold value that is entered in a text box with a respective thresholding rule (e.g. “<”, “>”, “>=”, “<=”, etc.); and assigning workflow positions to roles, which may, for instance, be performed to any user role when defining new or editing existing user roles. A non-limiting example of a reporting period workflow position may be: a hauler reporting period requires two levels of review and approval if the payment amount of the reporting period is less than $500 000, and a hauler reporting period requires three levels of review and approval if the payment amount of the reporting period is greater than or equal to $500 000.

In another example, and in accordance with at least one embodiment, a PRO Admin user may create application workflow positions, define application approval thresholds, and/or assign workflow positions to roles. For instance, an application workflow position may be created by navigating to a page within a UI that contains a button for creating a new position, whereby clicking the button enables the user to enter information related to a position name (e.g. “Application Reviewer 1,” “Application Approver,” etc.), description, and participant type (optionally selectable via a dropdown menu of available participants). There may also be included within the UI buttons to save, edit, or delete the position. An application approval threshold may be similarly defined by navigating to an appropriate page within the UI and specifying how many levels of approval are required for an application. Users may be able to create as many application workflow positions as required and assign respective numbers of workflow positions as necessary for a participant type. For example, “Participant Type 1” may first require review and approval from “Application Reviewer 1” followed by review and approval from “Application Approver,” while “Participant Type 2” may require review and approval from “Application Reviewer 1,” then “Application Reviewer 2,” then “Application Approver.” A user may also be able to assign a workflow position to any user role when defining or editing existing user roles, in accordance with at least one embodiment.

A material management platform, in accordance with at least one embodiment, is secure for all users, with all systems, and user and material data kept safe, private and protected. The hosting environment for at least one of the systems herein described is firewalled, with data such as banking information and the like encrypted using industry standard security methods and algorithms, examples of which include, but are not limited to, SSL or HTTPS, the implementation of which is appreciated by the skilled artisan. Users may, in accordance with at least one embodiment, be able to see security implementations when browsing a UI and/or their instance(s) of material management.

Flexibility, ease-of-use, versatility and configurability of a material management platform, in accordance with at least one embodiment, is the presentation of all information in highly sortable, customisable, filterable tabular format for ease of viewing and use for all users. Such a platform may commonly list information with columns and rows, or data tables. Users can sort and filter the contents of data tables that are well formatted and feature-rich to rapidly find desired information. Data tables may contain indicators displaying the number of records being shown or found by a filter, and may be exported for the purpose of, for instance, viewing the information in a third-party application or software, such as Microsoft Excel. Indicators may also be visible when viewing a data table and more information is populated into it, an example of which may be that if a transaction data table is being viewed, a newly synced transaction that is added to the corresponding instance of material management may be brought to the attention of the viewer via an indicator. Columns of data tables may also be hidden, shown, reordered, or sorted via criteria applicable to one or more columns by the user such that information may be displayed in a desired fashion. Filtering may also be applied by the user for the purpose of, for instance, only seeing records that meet a criterion. Such actions may be implemented via the presentation and manipulation of interactive buttons and fields within a UI.

A UI, in accordance with at least one embodiment, may have enhanced functionality through improved user experience as realised by an aesthetically pleasing presentation with artistic themes, navigation bars (placed, for instance, on the left and top portions of the UI), a dashboard corresponding to modules and/or accounts for the purpose of seeing high-level information, metrics, and the ability to quickly access more details, icons that distinctly represent various functions that are consistent across elements of the platform, feedback on forms for the ability to know that information entered is valid and accepted, and the ability to know where the user is within the platform through the display of navigational information that is consistent across the platform.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. A digital material treatment management system comprising:
a digitally executed material treatment management instance configuration interface digitally accessible to respective instance management authorities via corresponding digital communication network connections and comprising digitally executable instructions to digitally define, for respectively configurable material treatment management instances and based on respective digital inputs from said respective instance management authorities, respective prescribed material treatment process streams each respectively comprising multiple predefined material treatment transactions;
a digitally executed material treatment management instance participant interface digitally accessible to respective instance participant authorities via corresponding digital communication network connections and comprising digitally executable instructions to acquire, for each of said respective material treatment management instances and in respect of each of said respective instance participant authorities, digital data representative of respective material treatment transactions in compliance with said respectively predefined material treatment streams; and
a network-accessible digital processing environment storing network-executable instructions to concurrently execute said respectively configured material treatment management instances and compile, for each one thereof, said digital data representative of each of said predefined material treatment transactions associated therewith for compliance with its predefined material treatment stream.

2. The system of claim 1, wherein at least some of said respective prescribed material treatment process streams are defined in accordance with respective material treatment regulations, and wherein said network-accessible digital processing environment actively compiles said digital data for compliance with said respective material treatment regulations.

3. The system of claim 2, wherein said respective material treatment regulations comprise respective jurisdictional or material-specific treatment regulations.

4. The system of claim 1, wherein at least some of said respective prescribed material treatment process streams have defined in association therewith respective material treatment performance metrics, and wherein said network-accessible digital processing environment actively compiles said digital data against said respective material treatment performance metrics.

5. (canceled)

6. The system of claim 1, wherein a given instance is related to a given material recovery process for a prescribed product type, and wherein said digital data associated with a given transaction comprises a constituent product material identifier and value representative of a constituent product material and constituent material quantity treated in said given transaction.

7. The system of claim 6, wherein said prescribed product type has multiple constituent materials associated therewith as predefined via said configuration interface, and wherein said constituent product material identifier is selectable from multiple such identifiers via said participant interface.

8. The system of claim 7, wherein a given respectively predefined material treatment stream comprises multiple constituent material recovery streams respectively associated with said multiple constituent materials such that each of said multiple constituent material recovery streams are monitored via said network-accessible digital processing environment for compliance by said management authority or a third-party oversight authority designated thereby or associated therewith.

9. The system of claim 8, wherein at least some of said constituent material recovery streams comprise distinct designated material treatment transaction types.

10. The system of claim 6, wherein said participant authorities comprise at least one of a material producer, collector, hauler, post-consumption processor, sorter, manufacturer, consumer, recycler, or safe disposal manager.

11. The system of claim 6, wherein said instance management authorities comprise at least one of a Producer Responsibility Organisation (PRO), stewardship, oversight compliance officer, or third-party auditor.

12. A computer-implemented process executable to implement a digital material treatment management process by:
digitally interfacing with a material treatment management instance configuration interface digitally accessible to respective instance management authorities via corresponding digital communication network connections and comprising digitally executable instructions to digitally define, for respectively configurable material treatment management instances and based on respective digital inputs from said respective instance management authorities, respective prescribed material treatment process streams each respectively comprising multiple predefined material treatment transactions;
digitally interfacing with a material treatment management instance participant interface digitally accessible to respective instance participant authorities via corresponding digital communication network connections and comprising digitally executable instructions to acquire, for each of said respective material treatment management instances and in respect of each of said respective instance participant authorities, digital data representative of respective material treatment transactions in compliance with said respectively predefined material treatment streams;
concurrently executing said respectively configured material treatment management instances and compiling, for each one thereof, said digital data representative of each of said predefined material treatment transactions associated therewith for compliance with its predefined material treatment stream.

13. The process of claim 12, wherein at least some of said respective prescribed material treatment process streams are defined in accordance with respective material treatment regulations, and wherein said compiling comprises actively compiling said digital data for compliance with said respective material treatment regulations.

14. The process of claim 13, wherein said respective material treatment regulations comprise respective jurisdictional or material-specific treatment regulations.

15. The process of claim 12, wherein at least some of said respective prescribed material treatment process streams have defined in association therewith respective material treatment performance metrics, and wherein said compiling comprises actively compiling said digital data against said respective material treatment performance metrics.

16. (canceled)

17. The process of claim 12, wherein a given instance is related to a given material recovery process for a prescribed product type, and wherein said digital data associated with a given transaction comprises a constituent product material identifier and value representative of a constituent product material and constituent material quantity treated in said given transaction.

18. The process of claim 17, wherein said prescribed product type has multiple constituent materials associated therewith as predefined via said configuration interface, and wherein said constituent product material identifier is selectable from multiple such identifiers via said participant interface.

19. The process of claim 18, wherein a given respectively predefined material treatment stream comprises multiple constituent material recovery streams respectively associated with said multiple constituent materials such that each of said multiple constituent material recovery streams are monitored for compliance by said management authority or a third-party oversight authority designated thereby or associated therewith.

20. The process of claim 19, wherein at least some of said constituent material recovery streams comprise distinct designated material treatment transaction types.

21. (canceled)

22. The process of claim 17, wherein said instance management authorities comprise at least one of a Producer Responsibility Organisation (PRO), stewardship, oversight compliance officer, or third-party auditor.

23. A computer-readable medium comprising digitally executable instructions stored thereon for execution by a digital processor to implement a digital material treatment management process by:
digitally interfacing with a material treatment management instance configuration interface digitally accessible to respective instance management authorities via corresponding digital communication network connections and comprising digitally executable instructions to digitally define, for respectively configurable material treatment management instances and based on respective digital inputs from said respective instance management authorities, respective prescribed material treatment process streams each respectively comprising multiple predefined material treatment transactions;
digitally interfacing with a material treatment management instance participant interface digitally accessible to respective instance participant authorities via corresponding digital communication network connections and comprising digitally executable instructions to acquire, for each of said respective material treatment management instances and in respect of each of said respective instance participant authorities, digital data representative of respective material treatment transactions in compliance with said respectively predefined material treatment streams;
concurrently executing said respectively configured material treatment management instances and compiling, for each one thereof, said digital data representative of each of said predefined material treatment transactions associated therewith for compliance with its predefined material treatment stream.

24.-36. (canceled)
